(19) United States
(12) Patent Application Publication
(10) Pub. No.: US 2024/0107129 A1
(43) Pub. Date: Mar. 28, 2024

(54) METHOD AND APPARATUS FOR ENCAPSULATING IMAGE DATA IN A FILE FOR PROGRESSIVE RENDERING

(71) Applicant: CANON KABUSHIKI KAISHA, Tokyo (JP)

(72) Inventors: Hervé RUELLAN, RENNES (FR); Franck DENOUAL, SAINT DOMINEUC (FR); Frédéric MAZE, LANGAN (FR); Naël OUEDRAOGO, VAL D'ANAST (FR); Masanori FUKADA, Tokyo (JP)

(21) Appl. No.: 18/257,236

(22) PCT Filed: Dec. 15, 2021
(86) PCT No.: PCT/EP2021/086002

§ 371 Date: Jun. 13, 2023

(30) Foreign Application Priority Data
Dec. 17, 2020 (GB) 2020066.3
Apr. 13, 2021 (GB) 2105269.1
Apr. 23, 2021 (GB) 2105852.4

(51) Int. Cl. H04N 21/854; H04N 21/2343; H04N 21/84

(52) U.S. Cl. CPC H04N 21/854; H04N 21/234327; H04N 21/23439; H04N 21/84

(57) ABSTRACT

A method of encapsulating image data in a media file, the image data being related to a main image to be generated based on a plurality of sub-images, wherein the method comprises: obtaining the plurality of sub-images, each sub-image being provided in at least one version; generating descriptive metadata for describing the main image and the plurality of sub-images; encapsulating the plurality of sub-images and the descriptive metadata in the media file; wherein the method further comprises: generating a progressive information defining a set of consecutive progressive steps for generating a version of the main image, each progressive step being associated with a set of sub-images versions required to generate the version of the main image; and embedding the progressive information in the descriptive metadata.

### FIELD OF THE INVENTION

The present disclosure concerns a method and a device for encapsulating image data in a file. It concerns more particularly a method of encapsulation allowing a progressive rendering of an image.

### BACKGROUND OF INVENTION

Images displayed to a user can be loaded from a local disk, a network disk or from a remote server. To be loaded, the images are typically encapsulated within a file comprising the image data and metadata. The metadata are used to describe the organisation of the image data in the file, the type of the content and any useful information for the rendering or the image data.

The images are typically encoded to reduce the size of data on the storage device. Many encoding standards may be used, like JPEG, AV1, or the more recent HEVC or VVC standards.

The HEVC and VVC standards define profiles for the encoding of still images and describe specific tools for compressing single still images or bursts of still images. An extension of the ISO Base Media File Format (ISOBMFF) used for such kind of image data has been proposed for inclusion into the ISO/IEC 23008 standard, in Part 12, under the name: “HEIF” or “High Efficiency Image File Format”.

HEIF (High Efficiency Image File Format) is a standard developed by the Moving Picture Experts Group (MPEG) for storage and sharing of images and image sequences.

The MIAF (Multi-Image Application Format) is a standard developed by MPEG into ISO/IEC 23000 standard part 22. The MIAF specification specifies a multimedia application format, the Multi-Image Application Format (MIAF), which enables precise interoperability points for the creation, reading, parsing and decoding of images embedded in the High Efficiency Image File (HEIF) format. The MIAF specification fully conforms to the HEIF format and only defines additional constraints to ensure higher interoperability.

Depending on the location of the image, loading the image from the local or remote storage system may require a delay long enough to be noticeable by a user. Some formats, such as JPEG or JPEG-2000 enable a progressive rendering of images where a full but low-quality version of the image is contained in the beginning of the file. This low-quality version of the image is refined, possibly in multiple passes by the rest of the file, providing a full-quality version with the whole file. A progressive format enables to quickly display a full-size preview version of the image without waiting for the full reception of the image. As such it increases the reactivity of the displaying of images that are loaded slowly and improves the user experience.

The HEIF format has no explicit support for progressive rendering.

HEIF defines derived images that are representations of images built by applying an operation on other images present in the same file. Two types of derived images in particular are the grid type and the overlay type. A grid is an array of smaller images that all have the same size. An overlay defines a derived image by overlaying one or more images in a given layering order within a larger canvas.

The HEIF and MIAF file formats do not provide a mechanism allowing a progressive rendering of the grid and overlay derived image items. In particular, there is no description on how to progressively build from their individual components and render as a whole, progressively, a derived image of the grid type or of the overlay type, or for any type of derived image based on a plurality of input images.

The HEIF and MIAF file formats also do not provide a mechanism allowing a progressive rendering of multi-layer images.

### SUMMARY OF THE INVENTION

The present invention has been devised to address one or more of the foregoing concerns. It concerns a method and device for encapsulating image data in a file in view of the progressive rendering of the image. It concerns more particularly, images built based on a plurality of input images. It applies in particular to derived images of the type grid or overlay, but is not limited to these types of images.

According to a first aspect of the invention, there is provided a method of encapsulating image data in a media file, the image data being related to a main image to be generated based on a plurality of sub-images, wherein the method comprises:
obtaining the plurality of sub-images, each sub-image being provided in at least one version;
generating descriptive metadata for describing the main image and the plurality of sub-images;
encapsulating the plurality of sub-images and the descriptive metadata in the media file;
wherein the method further comprises:
generating a progressive information defining a set of consecutive progressive steps for generating a version of the main image, each progressive step being associated with a set of sub-images versions required to generate the version of the main image; and
embedding the progressive information in the descriptive metadata.

In an embodiment, each sub-image represents a different subset of the layers of the main image.

In an embodiment, sub-images are input images, at least one input image being associated with different versions of the input image.

In an embodiment, the progressive information comprises, for each progressive step, a position in the file of the sub-image version data associated with the progressive step.

In an embodiment, wherein the position indicates the last byte of sub-image version data in the file associated with the progressive step.

In an embodiment, wherein the position comprises an offset and a length to indicate the sub-image version data associated with the progressive step.

In an embodiment, the position comprises a list of extents of the sub-image version data associated with the progressive step.

In an embodiment, sub-image data being organized into one or more extent, each extent being composed of contiguous image data related to a version of one sub-image, the progressive information comprises, in descriptive metadata describing an extent, an information indicating that the last byte of the extent corresponds to a progressive step.

In an embodiment, sub-image versions being described as image items, the progressive information comprises for each progressive step a list of the image item identifiers identifying the image items associated with the progressive step.

In an embodiment, the progressive information comprises for each progressive step a number of input image versions comprised in the progressive step.

In an embodiment, at least one input image being composed of a plurality of layers, each layer being associated with a version of the input image, the progressive information further comprises a layer identifier associated with the image item identifier of the input image.

In an embodiment, generating a progressive information comprises generating a progressive refinement data structure comprising data for determining the location of reconstruction points in the media file, each reconstruction point indicating that a reconstruction of the main image is possible using image data associated to sub-image versions previously received.

In an embodiment, the progressive refinement data structure further comprises a number of reconstruction points.

In an embodiment, the progressive information characterizes a construction of the main image so that its quality is gradually improved.

In an embodiment, the progressive information is associated with the main image.

In an embodiment, the main image is part of an entity group, and the progressive information is associated with the entity group.

According to another aspect of the invention, there is provided a method of generating a main image to be generated based on a plurality of sub-images from an image data file, wherein the method comprises:
obtaining, from the image data file, descriptive metadata describing the main image and the plurality of sub-images, each sub-image being provided in at least one version;
obtaining, from the descriptive metadata, a progressive information defining a set of consecutive progressive steps for generating a version of the main image, each progressive step being associated with a set of sub-image versions required to generate the version of the main image;
obtaining image data corresponding to the sub-images from the image data file; and
generating at least two versions of the main image corresponding to respective progressive steps, each version of the main image being generated when the set of sub-image versions associated with the respective progressive step is obtained from the image data file.

According to another aspect of the invention, there is provided a computer program product for a programmable apparatus, the computer program product comprising a sequence of instructions for implementing a method according to the invention, when loaded into and executed by the programmable apparatus.

According to another aspect of the invention, there is provided a computer-readable storage medium storing instructions of a computer program for implementing a method according to the invention.

According to another aspect of the invention, there is provided a computer program which upon execution causes the method of the invention to be performed.

According to another aspect of the invention, there is provided a device for encapsulating image data in a media file, the image data being related to a main image to be generated based on a plurality of sub-images, wherein the device comprises a processor configured for:
obtaining the plurality of sub-images, each sub-image being provided in at least one version;
generating descriptive metadata for describing the main image and the plurality of sub-images;
encapsulating the plurality of sub-images and the descriptive metadata in the media file;
wherein the method further comprises:
generating a progressive information defining a set of consecutive progressive steps for generating a version of the main image, each progressive step being associated with a set of sub-images versions required to generate the version of the main image; and
embedding the progressive information in the descriptive metadata.

According to another aspect of the invention, there is provided a device for generating a main image to be generated based on a plurality of sub-images from an image data file, wherein the device comprises a processor configured for:
obtaining, from the image data file, descriptive metadata describing the main image and the plurality of sub-images, each sub-image being provided in at least one version;
obtaining, from the descriptive metadata, a progressive information defining a set of consecutive progressive steps for generating a version of the main image, each progressive step being associated with a set of sub-image versions required to generate the version of the main image;
obtaining image data corresponding to the sub-images from the image data file; and
generating at least two versions of the main image corresponding to respective progressive steps, each version of the main image being generated when the set of sub-image versions associated with the respective progressive step is obtained from the image data file.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”.

Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g., a microwave or RF signal.

### BRIEF DESCRIPTION OF THE DRAWINGS

Embodiments of the invention will now be described, by way of example only, and with reference to the following drawings in which:

FIG. 1 illustrates an example of a HEIF file that contains media data like one or more still images and possibly one or more video and/or one or more sequences of images;

FIG. 2 illustrates a first example of file structure for enabling a progressive rendering of a grid item;

FIG. 3 illustrates another file structure for enabling a progressive rendering of a similar grid item;

FIG. 4a to 4c illustrate different ordering of the image data in an image file;

FIG. 4d illustrates another example where the same ordering as FIG. 4b is used in relation with four different progressive steps;

FIG. 4e represents another example where a different ordering than FIG. 4c is used in relation with four different progressive steps;

FIG. 4f illustrates the rendering of the grid image item after the second progressive step corresponding to FIG. 4d;

FIG. 4g illustrates the rendering of the grid image item after the second progressive step corresponding to FIG. 4e;

FIG. 5 illustrates the main steps of generating an HEIF file according to embodiments of the invention;

FIG. 6 illustrates the main steps for a progressive rendering of an HEIF file generated according to embodiments of the invention;

FIG. 7 illustrates the main steps for a progressive rendering of an HEIF file generated according to other embodiments of the invention;

FIG. 8 is a schematic block diagram of a computing device for implementation of one or more embodiments of the invention;

FIG. 9 illustrates an example of associating a thumbnail and a preview with an image item for providing a progressive rendering for the image item;

FIG. 10 illustrates an example of using an item property for describing progressive rendering steps based on the encoding layers of an image item;

FIG. 11 illustrates an example of using an item property for describing progressive rendering steps based on the input image items of a derived image item; and

FIG. 12 illustrates an example of progressive rendering steps for a derived image item based on the encoding layers of its input image item.

### DETAILED DESCRIPTION OF THE INVENTION

The HEVC or VVC standard defines a profile for the encoding of still images and describes specific tools for compressing single still images or bursts of still images. An extension of the ISO Base Media File Format (ISOBMFF) used for such kind of image data has been proposed for inclusion into the ISO/IEC 23008 standard, in Part 12, under the name: “HEIF” or “High Efficiency Image File Format”.

The HEIF and MIAF standards cover two forms of storage corresponding to different use cases:
the storage of image sequences, which can be indicated to be displayed as a timed sequence or by other means, and in which the images may be dependent on other images, and
the storage of a single coded image or a collection of independently coded images, possibly with derived images.

In the first case, the encapsulation is close to the encapsulation of the video tracks in the ISO Base Media File Format (see document «Information technology—Coding of audiovisual objects—Part 12: ISO base media file format», w18855, ISO/IEC 14496-12, Sixth edition, October 2019), and similar tools and concepts are used, such as the ‘trak’ boxes and the sample grouping for description of groups of samples. The ‘trak’ box is a file format box that contains sub boxes for describing a track, that is to say, a timed sequence of related samples.

Boxes, also called containers, are hierarchical data structures provided to describe the data in the files. Boxes are object-oriented building blocks defined by a unique type identifier (typically a four-character code, also noted FourCC or 4CC) and a length. All data in a file (media data and metadata describing the media data) is contained in boxes. There is no other data within the file. File-level boxes are boxes that are not contained in other boxes.

In the second case, a set of ISOBMFF boxes, the ‘meta’ boxes are used. These boxes and their hierarchy offer fewer description tools than the ‘track-related’ boxes (‘trak’ box hierarchy) and relate to “information items” or “items” instead of related samples. It is to be noted that the wording ‘box’ and the wording ‘container’ may be both used with the same meaning to refer to data structures that contain metadata describing the organization or/and properties of the image data in the file.

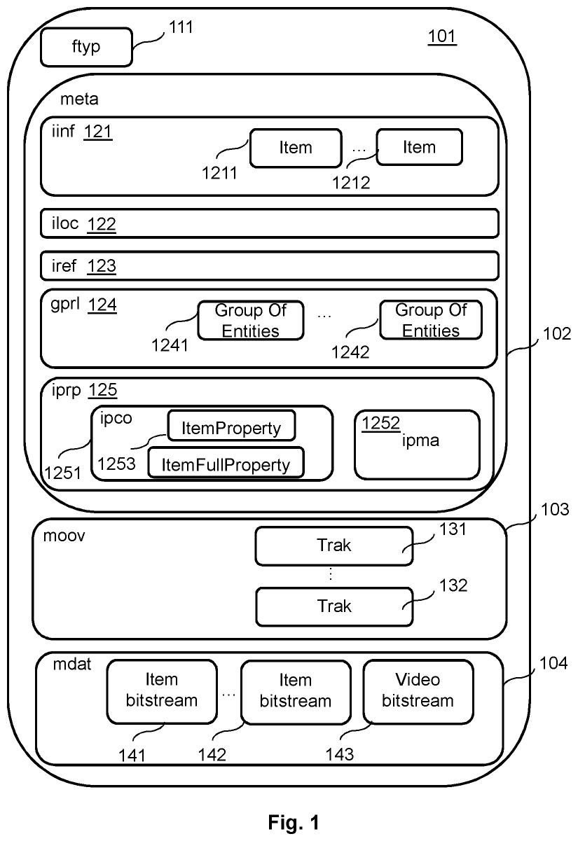

FIG. 1 illustrates an example of a HEIF file 101 that contains media data like one or more still images and possibly one or more video and/or one or more sequences of images. This file contains a ‘ftyp’ box (FileTypeBox) 111 that contains an identifier of the type of file (typically a set of four-character codes). This file contains a box called ‘meta’ (MetaBox) 102 that is used to contain general untimed metadata including metadata structures describing the one or more still images. This ‘meta’ box 102 contains an ‘iinf’ box (IteminfoBox) 121 that describes several single images. Each single image is described by a metadata structure ItemInfoEntry also denoted items 1211 and 1212. Each item has a unique 16-bit or 32-bit identifier item_ID. The media data corresponding to these items is stored in a container for media data, e.g., the ‘mdat’ box 104. The media data may also be stored in an ‘idat’ or in an ‘mdat’ box, in an ‘imda’ box or in another file. An ‘iloc’ box (ItemLocationBox) 122 provides for each item the offset and length of its associated media data in the ‘mdat’, ‘idat’, or ‘imda’ box 104. The media data for an item may be fragmented into extents. In this case, the ‘iloc’ box 122 provides the number of extents for the item and for each extent its offset and length in the ‘mdat’, ‘idat’, or ‘imda’ box 104. An ‘iref’ box (ItemReferenceBox) 123 may also be defined to describe the association of one item with other items via typed references.

Optionally, for describing the storage of image sequences or video, the HEIF file 101 may contain a box called ‘moov’ (MovieBox) 103 that describes one or more image sequences or video tracks 131 and 132. Typically, the track 131 may be an image sequence (‘pict’) track designed to describe a set of images for which the temporal information is not necessarily meaningful and 132 may be a video (‘vide’) track designed to describe video content. Both tracks describe a series of image samples, an image sample being a set of pixels captured at the same time, for example a frame of a video sequence. The main difference between the two tracks is that in ‘pict’ tracks the timing information is not necessarily meaningful whereas for ‘vide’ tracks the timing information is intended to constraint the timing of the display of the samples. The data corresponding to these samples is stored in the container for media data, the ‘mdat’ box 104.

The ‘mdat’ container 104 stores the untimed encoded images corresponding to items as represented by the data portions 141 and 142 and optionally the timed encoded images corresponding to samples as represented by the data portion 143 when a video track is also present in the HEIF file.

An HEIF file 101 offers different alternatives to store multiple images. For instance, it may store the multiple images either as items or as a track of samples that can be a ‘pict’ track or a ‘vide’ track. The actual choice is typically made by the application or device generating the file according to the type of images and the contemplated usage of the file.

A HEIF item is a derived image item, when it has a ‘dimg’ item reference to one or more other image items, which are inputs to the derivation.

An item with an item_type value of ‘iovl’ defines a derived image item by overlaying one or more input images in a given layering order within a larger canvas. The input images are listed in the order they are layered in the ‘dimg’ item reference for this derived image item. The data of the overlay image item specifies the location of each input image within the larger canvas.

An item with an item_type value of ‘grid’ defines a derived image item whose reconstructed image is formed from one or more input images in a given grid order within a larger canvas. The input images are listed in the grid order in the ‘dimg’ item reference for this derived image item. The data of the grid image item specifies the number of rows and columns in the grid and the size of the larger canvas.

The ISO Base Media File Format specifies several alternatives to group samples or items depending on the container that holds the samples or items to group. These alternatives can be considered as grouping data structures or grouping mechanism, i.e., boxes or data structures providing metadata describing a grouping criterion and/or group properties and/or group entities.

A first grouping mechanism represented by an EntityToGroupBox is adapted for the grouping of items or tracks. In this mechanism, the wording ‘entity’ is used to refer to items or tracks or other EntityToGroupBoxes. This mechanism specifies the grouping of entities. An EntityToGroupBox is defined according to the following syntax:

```
aligned(8) class EntityToGroupBox(grouping_type, version, flags)
extends FullBox(grouping_type, version, flags) {
  unsigned int(32) group_id;
  unsigned int(32) num_entities_in_group;
  for(i=0; i<num_entities_in_group; i++)
    unsigned int(32) entity_id;
/ / the remaining data may be specified for a particular grouping_type
}
```

The grouping_type is used to specify the type of the group. Several values for the grouping_type are specified in HEIF. The group_id provides an identifier for the group of entities. The entity_id represents the identifier of entities that compose the group, i.e., either a track ID for a track, an item_ID for an item or another group id for an entity group. In FIG. 1, the groups of entities inheriting from the EntityToGroup box 1241 and 1242 are comprised in the container 124 identified by the four characters code ‘gprl’ for GroupsListBox.

Entity grouping consists in associating a grouping type which identifies the reason of the grouping of a set of items, tracks or other entity groups. In this document, it is referred to Grouping Information as information in one of the EntityToGroup Boxes which convey information to group a set of images.

A grouping_type value of ‘altr’ indicates that the items and tracks mapped to this grouping are alternatives to each other, and only one of them should be rendered. A player should select the first entity in the grouping that it can process and that suits the application needs.

ISOBMFF provides a mechanism to describe and associate properties with items. These properties are called item properties. The ItemPropertiesBox ‘iprp’ 125 enables the association of any item with an ordered set of item properties. The ItemPropertiesBox consists of two parts: an item property container box ‘ipco’ 1251 that contains an implicitly indexed list of item properties 1253, and an item property association box ‘ipma’ 1252 that contains one or more entries. Each entry in the item property association box associates an item with its item properties. The HEIF standard extends this mechanism to enable the association of item properties with items and/or entity groups. Note that in the description, for genericity, we generally use item properties to designate both properties of an item or properties of an entity group. An item property associated with an entity group applies to the entity group as a whole and not individually to each entity within the group.

The associated syntax is as follows:

| aligned(8) class ItemProperty(property_type) | |
|---|---|
| extends Box(property_type) | |
| { | |
| } | |
| aligned(8) class ItemFullProperty(property_type, version, flags) | |
| extends FullBox(property_type, version, flags) | |
| { | |
| } | |
| aligned(8) class ItemPropertyContainerBox | |
| extends Box(‘ipco’) | |
| { | |
| properties ItemProperty( ) [ ]; / / boxes derived from | |
| / / ItemProperty or ItemFullProperty, to fill box | |
| } | |
| aligned(8) class ItemPropertyAssociation | |
| extends FullBox(‘ipma’, version, flags) | |
| { | |
| unsigned int(32) entry_count; | |
| for(i = 0; i < entry_count; i++) { | |
| if (version < 1) | |
| unsigned int(16) | item_ID; |
| else | |
| unsigned int(32) | item_ID; |
| unsigned int(8) association_count; | |
| for (i=0; i<association_count; i++) { | |
| bit(1) essential; | |
| if (flags & 1) | |
| unsigned int(15) | property_index; |
| else | |
| unsigned int(7) | property_index; |

```
    }
  }
}
aligned(8) class ItemPropertiesBox
    extends Box(‘iprp’) {
  ItemPropertyContainerBox property_container;
  ItemPropertyAssociation association[ ];
}
```

The ItemProperty and ItemFullProperty boxes are designed for the description of an item property. ItemFullProperty allows defining several versions of the syntax of the box and may contain one or more parameters whose presence is conditioned by either the version or the flags parameter.

The ItemPropertyContainerBox is designed for describing a set of item properties as an array of ItemProperty boxes or ItemFullProperty boxes.

The ItemPropertyAssociation box is designed to describe the association between items and/or entity groups and their item properties. It provides the description of a list of item identifiers and/or entity group identifiers, each identifier (item_ID) being associated with a list of item property index referring to an item property in the ItemPropertyContainerBox.

The goal of the invention is to provide a fine control over the granularity of a progressive rendering in HEIF of an image item that is built from several image components. Such an image item may be a grid derived image item (also denoted grid item), an overlay derived image item (also denoted overlay item) or any other type of derived image based on a plurality of input images. These are built from several input image items. Such an input image item may also be a coded image items encoded using HEVC tiles or layers or using VVC sub-pictures or layers. The rest of the description is based on grid items for clarity, but it could also apply to other image items built from several image components (also denoted input images).

In the following description, the target image of a progressive rendering is called the main image. The components or input images used to build this main image are called the sub-images. A progressive step refers to a reconstructed version of this main image. The initial progressive step corresponds to an empty image, while the final progressive step corresponds to the main image. Intermediate progressive steps may have a lower resolution and/or a lower quality than the main image. Note that in the following description, the initial progressive step is sometimes ignored for simplicity.

Possibly the progressive rendering functionality may be used for other purposes than displaying the image. For example, a process for detecting people on an image may use a fast first check on the low-quality version of the images for quickly rejecting images not containing people.

The progressive rendering of the main image is realized by using different coded versions of the sub-images. A reconstructed version of the main image may consist in decoding all the input images and assembling these decoded sub-images according to the type of the main image item (e.g., grid, overlay, sub-picture composition . . . ) A sub-image version may be the sub-image itself, a thumbnail of the sub-image, a lower quality and/or lower-resolution coded version of the sub-image. The different coded versions may also be contained in one or more layers of a multi-layer image. When the sub-image is encoded with several quality or resolution levels, the progressive rendering of the main image may use a subset of these quality or resolution levels. The content of a progressive step refers to the set of sub-image versions that are used during the reconstruction of the version of the main image corresponding to this progressive step. The refinements of a progressive step refer to the subset of sub-image versions that are part of the content of the progressive step and that were not part of the content of the previous progressive step.

Each progressive step may be associated with a reconstruction point. A reconstruction point is a location in the file corresponding to a point in the file where all the versions of input images required to generate the version of the main image corresponding to the progressive step have been run through. It means that, when reading the file, a reconstruction point is the point in the file where all the required image data for a given progressive step have been read.

When a sub-image is a multi-layer image, i.e., encoded with several quality or resolution layers, the sub-image may be represented by a single item whose media data contain all the encoded layers. Possibly, the media data corresponding to the different layers may be fragmented and described in the Item Location Box ‘iloc’ using extents. For example, the media data for a sub-image encoded as a multi-layer image with two layers may be located using two extents, each extent indicating the location of the data corresponding to a layer when this sub-image is described by one image item.

The multi-layer image may also be represented by several image items corresponding to the different layers, or different subsets of layers. These image items may share the common parts of the media data. For example, two different image items may correspond to a sub-image encoded as a multi-layer image with two layers. The first image item would correspond to the first layer and its media data would be located using an extent indicating the location of the data corresponding to the first layer. The second image item would correspond to the combination of both layers and its media data would be located using two extents indicating respectively the location of the data corresponding to the two layers. A description of the layers may also be available in an image property to indicate which layers are contained in an image item. Thus, each image item representing a sub-image encoded as a multi-layer image may be considered as a sub-image version, like different coded versions of a non-multi-layer image item.

When the main image is an HEVC image encoded with tiles or a VVC image encoded with sub-pictures, a sub-image may be an image item corresponding to a tile (e.g. ‘hvt1’ item) or to a sub-picture (e.g. ‘vvs1’ or ‘vvc1’ item). The main image may be an HEVC item, also called here HEVC base item, reconstructed from the tile sub-images that are associated to it using an item reference of type ‘tbas’ from each tile sub-image item to the base item, the positions of the tile sub-images being provided by an ‘rloc’ property. The main image may be a VVC base item reconstructed from the sub-picture sub-images that are associated to it using an item reference of type ‘subp’ from the base item to the sub-picture sub-image items. A sub-image version may be a tile or a sub-picture encoded at a given quality or resolution levels. A tile or a sub-picture may also be encoded as a multi-layer image and a version of such sub-image may be obtained by decoding a subset of its quality or resolution layers.

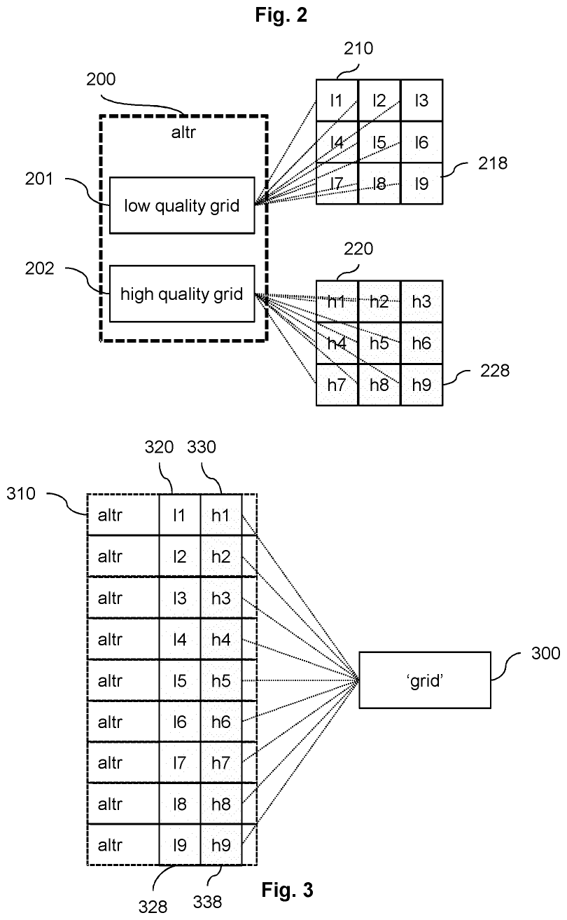

FIG. 2 illustrates a first example of file structure for enabling a progressive rendering of a grid item (the same would apply to an overlay or to an HEVC base item or to a VVC base item: overlay also references sub-images through a ‘dimg’ item reference type, while an HEVC base item is referred to by tile sub-images via a ‘tbas’ item reference type and a VVC base item references sub-images through a ‘subp’ item reference type). The main or primary image item is the grid item 202, “high-quality grid”, which is built using the nine sub-images “h1”, referenced 220, to “h9”, referenced 228. These sub-images are encoded with a high-quality. This main image is included in an entity group of type ‘altr’ 200 that also contains the grid item 201, “low-quality grid”, which is built using the 9 sub-images “l1”, referenced 210, to “l9”, referenced 218. These sub-images are encoded with a low-quality. A progressive rendering of the main image 202 may be realized by first rendering the grid item 201 once all the sub-images of low-quality 210 to 218 are available and then rendering the grid item 202 once all the sub-images of high-quality 220 to 228 are available. However, this file structure only provides two refinement steps. In particular, if the main image 202 is large with a good quality, the quantity of data corresponding to the sub-images 220 to 228 may be large and take some time to load. Moreover, there are no guarantee that the file organizes the data for low-quality versions and high-quality versions of the sub-images in a way enabling progressive refinement.

FIG. 3 illustrates another file structure for enabling a progressive rendering of a similar grid item. The main or primary image item is the grid item 300, composed of the nine sub-images “h1”, referenced 330, to “h9”, referenced 338, encoded in high-quality. Each sub-image is associated to a low-quality encoded alternative through an ‘altr’ entity group: the nine sub-images “h1” to “h9” are respectively associated to the nine sub-images “l1”, referenced 320, to “l9”, referenced 328. For example, the ‘altr’ entity group associating “h1” with “l1” is referenced 310. As such, the grid item may be reconstructed using either the low-quality version or the high-quality version of each sub-image, depending on which version is available for each sub-image. This file structure can provide up to ten different progressive steps: the first step consists of all the low-quality sub-images, the second step replaces one of these low-quality sub-images with a high-quality one, and so on until the tenth step where only the high-quality sub-images are used.

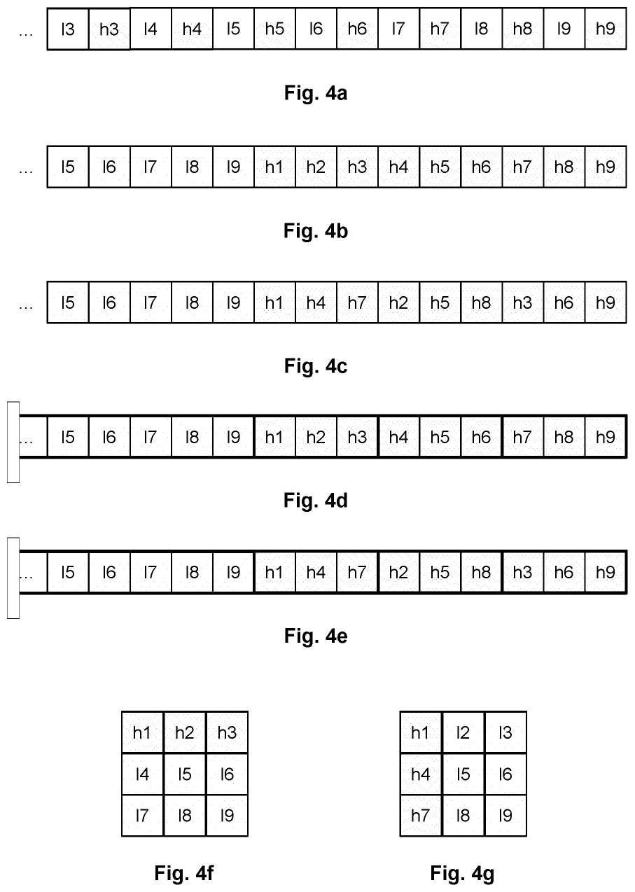

However, the actual progressive steps depend on the ordering of the sub-image data inside the HEIF file. FIG. 4a represents a first ordering where almost no progressive rendering is possible: the low-quality and the high-quality sub-images are interleaved in the HEIF file. As well, for multi-layer sub-images, base layer and enhancement layers may not be organized to have all the base layers first, then followed by all enhancement layers. As a consequence, no complete reconstruction of the grid item is possible until the penultimate sub-image, “l9”, is received. The main image can be reconstructed soon after this when the last sub-image, “h9”, is received.

FIG. 4b represents a second ordering better suited to progressive rendering, where all the low-quality sub-images occur first in the HEIF file, followed by all the high-quality sub-images. With this ordering, ten progressive steps are possible, from using only low-quality sub-images to using only high-quality sub-images. A new progressive step is possible after the loading of each high-quality image. The same data ordering may be used for multi-layer images to provide first the base layers and then the enhancement layers. In this case, the sub-images used by the main image have dependencies to other sub-image items, the data for depended on sub-image items should be placed before the data for the sub-image item.

FIG. 4c represents a third ordering also suited to progressive rendering with ten possible progressive steps, albeit using a different ordering for the high-quality sub-images. While the ordering of FIG. 4b provides a progressive rendering row-by-row, the ordering of FIG. 4c provides a progressive rendering column-by-column.

While the file structure described in relation to FIG. 3 enables more progressive steps than the structure described in relation to FIG. 2, it still has several drawbacks. First, a typical usage of a grid item may use a much larger number of input image items, resulting in many possible progressive steps. A larger number of progressive steps, while allowing for a smoother refinement of the image also requires more processing power, as the grid image has to be reconstructed at each step. Second, there is no guarantee that the ordering of sub-image versions in the HEIF file effectively enables a progressive rendering of the grid image. In addition, there is no indication on how this progressive rendering is organized, whether row by row, or column by column, or using another refinement pattern. An arbitrary refinement may lead to a bad user experience when looking at the image.

The invention proposes to extend HEIF by adding information about the organization of the file regarding progressive rendering. This information, hereafter named progressive information can take several forms that are detailed in the progressive embodiments described hereafter. This progressive information may include a progressive rendering strategy, or progressive strategy. Examples of progressive rendering strategy are the top-bottom ordering from FIG. 4b or the left-right ordering from FIG. 4c. This progressive information may also include the description of the progressive steps proposed by the file.

FIG. 4d represents another example where the same ordering as in FIG. 4b is used in relation with four different progressive steps: the initial progressive step containing only the low-quality sub-images, followed by three progressive steps, each adding a row of high-quality sub-images.

FIG. 4f illustrates the rendering of the grid image item after the second progressive step, when three high-quality sub-images corresponding to the first row of the grid have been received. In this example, the content of the second progressive step is the three high-quality sub-images h1 to h3 and the six low-quality sub-images 14 to 19. The refinements of this progressive step are the three high-quality sub-images h1 to h3.

FIG. 4e represents another example where the same ordering as in FIG. 4c is used in relation with four different progressive steps: the initial progressive step containing only the low-quality sub-images, followed by three progressive steps, each adding a column of high-quality sub-images.

FIG. 4g illustrates the rendering of the grid image item after the second progressive step, when three high-quality sub-images corresponding to the first column of the grid have been received. In this example, the content of the second progressive step is the three high-quality sub-images h1, h4 and h7 and the six low-quality sub-images 12, 13, 15, 16, 18 and 19. The refinements of this progressive step are the three high-quality sub-images h1, h4 and h7.

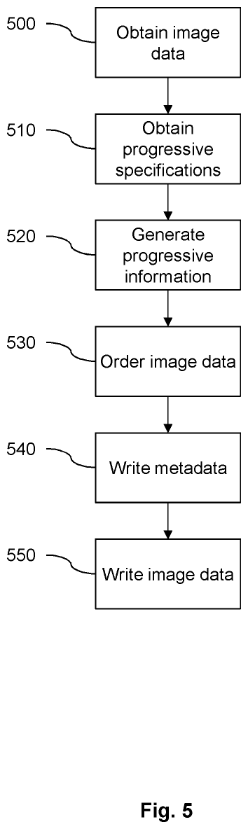

FIG. 5 illustrates the main steps of generating an HEIF file according to embodiments the invention.

In a first step 500, the image data to be contained in the HEIF file is obtained. In the example of FIG. 3, this image data consists of the nine low-quality sub-images and the nine high-quality sub-images. In addition, information about the structure of the HEIF file is obtained. This includes for example the type of the main image, its relations with the sub-images, and the relations between the sub-images. In the example of FIG. 3, this information is that the main image is a grid item, composed of the nine sub-images h1 to h9, and that each of these sub-images h1 to h9 has an associated low-quality sub-image ranging from 11 to 19.

In the second step 510, the progressive specifications for organizing the file content for progressive rendering of the main image is obtained. These progressive specifications are dependent on the selected progressive embodiment. These progressive specifications may be obtained directly from a user input, or from a configuration file, or may be determined through some processing. For example, a software component may determine the type of content represented by the main image and select the most appropriate progressive rendering strategy. If the main image corresponds to a landscape picture, it may select a top-bottom progressive strategy, while if the main image corresponds to a person whose face is in the centre of the image, it may select a centre-to-border progressive strategy. As another example, when an object or region of interest is present, the progressive rendering strategy may start by refining first the area surrounding the object or region of interest and then progressing towards the image borders.

In the next step 520, the progressive information to be included in the HEIF file is generated from the progressive specifications obtained at step 510. This generation depends on the selected progressive embodiment. These embodiments are described in detail below.

In the next step 530, the image data is ordered according to the progressive specifications. For example, if the progressive specifications indicate a top-bottom progressive rendering strategy as in the example of FIG. 4b, then the image data will be ordered as shown in FIG. 4b.

For this ordering step, the image data is organized into progressive data blocks. These progressive data blocks are ordered according to the progressive specifications.

When the main image is a grid item, there is a progressive data block containing the data for the grid item itself. There is also one progressive data block for each version of each sub-image composing the grid. In the example of FIG. 4b, there are nineteen progressive data blocks: the grid, the nine low-quality image data and the nine high-quality image data.

When the main image is an overlay item, there is a progressive data block containing the data for the overlay item itself, and one progressive data block for each version of each sub-image composing the overlay.

This may be transposed similarly for any kind of main image based on input sub-images.

When the main image is an HEVC image encoded with tiles or a VVC image encoded with sub-pictures, there may be one or more progressive data block for the image itself, and there may be one progressive data block for each version of each tile or sub-picture. When the sub-images are encoded as multi-layer images with several quality layers, for example a base layer and one or several enhancement layers, each layer corresponds to a progressive data block.

Possibly, a progressive data block may be further split into several sub-blocks.

Preferably, the data block containing the data related to the main image structure is placed first. For example, the data for the grid item (or for an overlay) itself is preferably placed first.

This ordering may also cover data not directly related to the main image. For example, there may be a progressive data block corresponding to the thumbnail of the main image. This progressive data block is preferably ordered before any progressive data block for the main image.

There may be progressive data blocks corresponding to metadata associated to the main image. Preferably these data blocks are ordered after all the progressive data blocks for the main image. Possibly these data blocks may be inserted between two progressive steps, for example when it is useful to process or render some metadata information before having loaded the main image. Some progressive specifications may indicate where to place these progressive data blocks.

There may be progressive data blocks corresponding to region items associated to the main image. Preferably these data blocks are ordered after all the progressive data blocks for the main image. Possibly these data blocks may be inserted between two progressive steps, for example when it is useful to process or render some region-related information before having loaded the main image. Some progressive specifications may indicate where to place these progressive data blocks.

In the next step 540, the metadata for the HEIF file are written. These metadata include the progressive information generated at step 520.

In the last step 550, all the progressive data blocks are written, in the order determined at step 530, in the media part of the file, like for example an ‘mdat’ box.

Possibly the ordering of steps 520 and 530 may be switched. This may be useful if the generating of the progressive information depends on the ordering of the progressive data blocks.

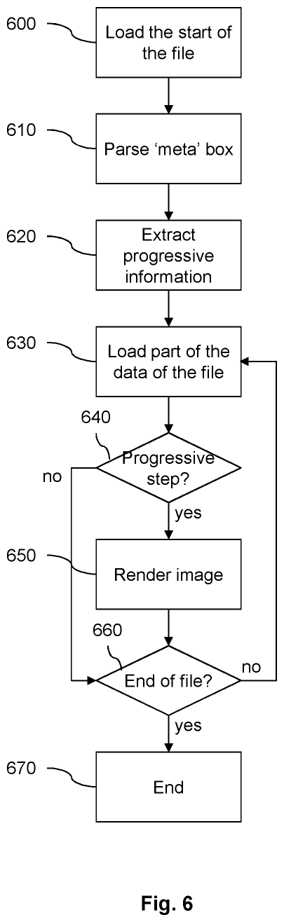

FIG. 6 illustrates the main steps for a progressive rendering of an HEIF file generated according to an example of the invention. These steps are intended to be executed while loading the HEIF file. The HEIF file may be loaded from a local storage, from a network storage, or received from a network server, for example using the HTTP protocol.

In the first step 600, the start of the HEIF file is loaded. This start of the HEIF file includes all the metadata composing the ‘meta’ box of the HEIF file.

In step 610, the ‘meta’ box is parsed to obtain the structure of the HEIF file, including for example the number of items, the type of these items, their relations, the properties associated with these items and so on. This ‘meta’ box may contain an ‘idat’ box providing the data defining the overlay item or grid item structure. It may also contain a thumbnail.

In the next step 620, the progressive information is extracted from the result of the parsing of step 610. The refinements of the progressive information depends on the selected progressive embodiment. As a part of this extraction, the progressive steps contained in the HEIF file are obtained. This obtaining depends on the selected progressive embodiment.

In the next step 630, a part of the data present in the file is loaded.

At step 640, it is checked whether the data corresponding to a new progressive step has been loaded. This check depends on the selected progressive embodiment.

If the result of the check is positive, the next step is step 650, where a new rendering of the version of the main image corresponding to this progressive step is realized. This rendering may include computing a reconstructed image from the sub-image versions corresponding to the progressive step reached. It may also include some post-processing computed on the version of the reconstructed image, such as rescaling it for fitting the display area, or applying a filter selected by the user. It may also include applying some transformative properties to the version of the reconstructed image, such as a rotation, a scaling, a mirroring or a crop.

Note that in some embodiments, a further check is realized based on the progressive information and the progressive step reached to determine if the version of the reconstructed image should be rendered. For example, if only part of the version of the main image is displayed, this further check may verify whether the progressive step reached provides refinements to the displayed part of the version of the reconstructed image.

If the result of the check at step 640 is negative and after step 650, then next step is step 660. This step checks whether the file has been fully received or not.

If the result of the check is negative, the next step is step 630, waiting for an additional part of the file to be received.

If the result of the check is positive, the next step is step 670 where the algorithm ends.

Note that at step 630, data corresponding to several refinement steps may be received. In this case, the check at step 640 will be positive and at step 650, the reconstructed image is rendered using the sub-images corresponding to the last progressive step reached.

Note that all these steps are intended for receiving the HEIF file in sequential order. However, they can easily be adapted to receiving the HEIF file as chunks in an arbitrary order. This adaptation mostly concerns steps 640 and 660. In these steps, the checks must take into account that the parts of the HEIF file may be received in an arbitrary order, verifying explicitly that all the data corresponding to a progressive step or to the whole file has been received and not taking advantage of a sequential reception of the HEIF file.

Different embodiments for encoding the progressive information in an HEIF file are now described.

Refinement Pattern Embodiment

In a first embodiment, hereinafter called the refinement pattern embodiment, the progressive information contained in an HEIF file is based on a progressive refinement pattern that defines the progressive refinement strategy used in the HEIF file. A progressive refinement pattern may be for example the top-bottom progressive refinement of FIGS. 4d and 4f or the left-right progressive refinement of FIGS. 4e and 4g. The progressive refinement pattern is indicative of a scanning order of the input images. A progressive step is defined when a set of versions of the input images corresponding to a step in the scanning order of the input image has been loaded allowing the rendering of a version of the main image. In other words, the progressive refinement pattern is indicative of the ordering of the refinements for the different spatial regions of the main image. For example, in the case of a grid item, the progressive refinement pattern is indicative of the ordering of the refinements for the different sub-images that compose the grid.

This first embodiment advantageously provides a compact signalization for the progressive information inside the HEIF file.

The progressive refinement pattern used inside an HEIF file may be exposed at the application level, allowing an application to select an HEIF file among several based on its progressive refinement pattern. For example, for the same main image, a first HEIF file may use a top-bottom progressive refinement and a second HEIF file may use a left-right progressive refinement. An application may select between these two files the one that is best suited to its needs.

Predefined refinement variant In a first variant of this first embodiment, hereinafter called the predefined refinement pattern variant, a list of progressive refinement pattern is predefined. The progressive information comprises an indication of one of the predefined progressive refinement patterns.

This variant advantageously allows a simple signalling of the progressive refinement strategy used in an HEIF file.

A progressive refinement pattern may be represented as an item property associated with the image item to which it applies. This progressive refinement pattern item property may be described by the following structure:

| aligned(8) class ProgressivePatternProperty | |
|---|---|
| extends ItemFullProperty(‘ppat’, version = 0, flags = 0) { | |
| unsigned int(8) | pattern_type; |
| unsigned int(1) | reverse_flag; |
| unsigned int(1) | bidirectional_flag; |
| unsigned int(1) | parameter_flag; |
| unsigned int(5) | reserved; |
| unsigned int(8) | scale; |
| if (parameter_flag == 1) { | |
| unsigned int(32) | parameter; |

}
}

This progressive refinement pattern item property may be identified, for example, by the ‘ppat’ 4cc. Another 4cc may be used.

In this structure, the pattern_type specifies the type of the refinement pattern used. Several refinement pattern types may be defined, including: top-bottom, left-right, top-left to bottom-right diagonal, bottom-left to top-right diagonal, centre to border, clockwise . . . In addition, specific refinement pattern types for an overlay may be defined, as for example front to back or largest to smallest.

As an example, the following values may be defined for the pattern_type:
When equal to 0, the refinement is done from top to bottom on a row basis; This guarantees that data for the input images are ordered on a row basis.
When equal to 1, the refinement is done from left to right on a column basis;
When equal to 2, the refinement is done from top-left to bottom-right on a diagonal basis
When equal to 3, the refinement is done from centre to border;
When equal to 4, the refinement is done on an input image item basis in a counter clockwise order;
When equal to 5, the refinement is done on an input image item basis from front to back (i.e., according to the layering order of an overlay);
When equal to 6, the refinement is done on an input image item basis from largest item to smallest item.

The reverse_flag indicates that the ordering defined by the refinement pattern is reversed. For example, the top-bottom refinement pattern becomes a bottom to top refinement pattern with the reverse flag. Possibly, this flag may be removed from the ProgressivePatternProperty and be replaced with new refinement pattern types. For example, a bottom-top refinement pattern type could be added.

The bidirectional_flag indicates that the ordering starts from both ends defined by the refinement pattern. For example, the top-bottom refinement pattern becomes a refinement pattern where the progressive refinement starts from both the top and bottom rows and progress towards the centre row. This flag may be combined with the reverse_flag, reversing the order obtained after applying the reordering associated with the bidirectional_flag. Possibly, this bidirectional_flag may be removed from the ProgressivePatternProperty and be replaced with new refinement pattern types. For example, a bottom and top to centre refinement pattern type could be added.

The parameter_flag indicates whether a parameter value is present for the refinement pattern. If the value of this flag is 1, then the parameter value is present in the item property. The meaning of this parameter value depends on the refinement pattern type. For example, a clockwise refinement pattern may start by default from a position corresponding to midday on a clock continuing in a clockwise order. The parameter value for this refinement pattern may indicate a different starting position by indicating a different starting hour, or by giving a starting angle in degree. The parameter value may be present for all the refinement pattern types. It may also be absent for all the refinement pattern types. The presence of the parameter value may depend on the pattern type. The parameter value may be a set of values or a more complex structure.

The scale value indicates that the progressive steps defined by the refinement pattern type are grouped together into a single coarser step (denoted scaled progressive step). In such a case, only scaled progressive steps should be rendered by the reader and not each single progressive step. The scale value may indicate how many progressive steps are grouped together. For example, a scale value of 2 for a left-right refinement pattern type indicates that each scaled progressive step's refinements contain the refinement for two columns at once. The scale value may also be a fractional value. In this case, the scaled progressive step n for the refinement pattern specified by the item property corresponds to the progressive step number └n×scale┘ as defined by the refinement pattern type, i.e., the rounded-down value of the index n of the progressive step multiplied by the scale value. In this formula, the initial step corresponding to the low-quality version of the sub-images is numbered 0. For example, with a scale value of 1.5, a top-bottom ordering alternates scaled progressive steps adding 1 or 2 rows of high-quality images. Possibly, this scale value may be removed from the ProgressivePatternProperty and be replaced with new refinement pattern types. For example, there may be a top-bottom by 2 rows refinement pattern type.

In a variant, the scale value may be replaced by a list of numbers indicating how many progressive steps are grouped into each scaled progressive step. For example, if the list has the values [2, 1, 3] for a top-bottom refinement pattern, then the first scaled progressive step's refinements contain 2 rows of high-quality sub-images, the next one 1 row, and the last one 3 rows. If there are more progressive steps than the sum of the values contained in the list, the list may be repeated to continue grouping the progressive steps, the remaining progressive steps may be grouped using a default group size, or the remaining progressive steps may be kept alone.

In this embodiment, in step 510 of FIG. 5, the obtained progressive specifications include the pattern type and may include a flag indicating whether a reverse ordering is used, a flag indicating whether a bidirectional ordering is used, a scaling value for the progressive steps, and a parameter value associated with the pattern type.

In step 520 of FIG. 5, an item property structure is generated for representing all these specifications. This item property structure is written as a part of the ‘meta’ box of the HEIF file at step 540 and is associated with the image item corresponding to the main image in the HEIF file. For example, the item property structure is written as part of the item property container box ‘ipco’ and is associated with the image item corresponding to the main image via an item property association box ‘ipma’.

In step 530 of FIG. 5, the ordering defined by the pattern type is retrieved and applied to the progressive data blocks. This ordering may be modified by the reverse flag and the bidirectional flag.

In this embodiment, in step 620 of FIG. 6, the progressive information for an image item is extracted by parsing the progressive refinement pattern property item associated with this image item. Using the pattern type specified in the progressive refinement pattern property item and the different flags and values contained in this property item, the list of progressive steps is computed. Each progressive step is specified by the list of sub-image versions it adds to the previous progressive step. For example, in the case of FIG. 4f, the pattern is a top-bottom pattern. There is three progressive steps: one for each row of the grid item. And each progressive step contains three sub-image versions, corresponding to the three columns of the grid item.

At step 640, it is checked whether all the sub-image versions contained in the list associated with a progressive step (or a scaled progressive step when the scale value is present and not equal to 1) have already been loaded.

Possibly, no progressive step is computed at step 620. In this case, the check of step 640 may be based on the number of sub-image versions received. For example, the check may be positive each time a new predefined number of new sub-image versions has been received, or when the number of new sub-image versions received is a predefined percentage of the total number of sub-image versions. Possibly low-quality sub-image versions may not be taken into account in these checks.

The check may also be based on the number of bytes received. For example, the check may be positive each time a new predefined number of bytes has been received, or when the number of newly received bytes is a predefined percentage of the total number of bytes of the HEIF file. Possibly, bytes corresponding to the content of low-quality sub-image versions and/or the content of the HEIF file structure, such as the ‘meta’ box may not be taken into account in these checks.

In a variant, the scale value may be replaced by a scale_fraction value indicating how many progressive steps are grouped together into scaled progressive steps as a fraction of the total number of progressive steps.

In another variant, the scale value may be replaced by a scale_number value indicating that the progressive steps are grouped together into a number of scaled progressive steps equal to this scale_number value.

Analytic Refinement Patterns

In a second variant of the first embodiment, hereinafter called the analytic refinement patterns, progressive refinement patterns are defined in an analytic way. In this embodiment, the progressive information comprises an indication of a scanning order of the input images based on an equation and associated parameters.

This variant advantageously enables a rich expressivity in the possible progressive refinement patterns used in HEIF files.

An analytic refinement patterns may be defined inside the progressive refinement pattern item property. The structure of this progressive refinement pattern item property may be:

| aligned(8) class ProgressivePatternProperty | |
|---|---|
| extends ItemFullProperty(‘ppat’, version = 0, flags = 0) { | |
| unsigned int(2) | pattern_type; |
| unsigned int(1) | bidirectional_flag; |
| unsigned int(5) | reserved; |
| / / Linear | |
| if (pattern_type == 0) { | |
| unsigned int(8) | start_x; |
| unsigned int(8) | start_y; |
| unsigned int(8) | end_x; |
| unsigned int(8) | end_y; |
| unsigned int(16) | step_numerator; |
| unsigned int(16) | step_denominator; |
| } | |
| / / Radial | |
| else if (pattern_type == 1) { | |
| unsigned int(8) | center_x; |
| unsigned int(8) | center_y; |
| int(16) | step_numerator; |
| unsigned int(16) | step_denominator; |
| } | |
| / / Circular | |
| else if (pattern_type == 2) { | |
| unsigned int(8) | center_x; |
| unsigned int(8) | center_y; |
| unsigned int(16) | starting_angle; |
| int(16) | step_numerator; |
| unsigned int(16) | step_denominator; |

}
}

In this structure, the pattern_type indicates the general type of the refinement pattern, for example whether it is linear, radial or circular.

The bidirectional_flag indicates that the ordering starts from both ends defined by the refinement pattern.

If the pattern_type value is 0, then the refinement pattern is a linear refinement pattern. A linear refinement pattern may be for example a top-bottom refinement pattern, or a left-right refinement pattern.

The start_x and start_y values indicate the starting point of the refinement pattern, which is the centre of the grid item whose coordinates in the grid are given by these values.

Similarly, the end_x and end_y values indicate the ending point of the refinement pattern, which is the centre of the grid item whose coordinates in the grid are given by these values.

Last, the step_numerator and step_denominator values indicate the size (equal to step_numerator divided by step_denominator) of each progressive refinement step.

To determine to which progressive step the high-quality version of a sub-image of the grid item belongs to, the following computation is realized using grid coordinates. First, the centre of the grid item is orthogonally projected on the line defined by the starting and ending point. The distance of this projected point from the starting point is computed. This distance is considered positive if the projected point belongs to the half line also containing the ending point, and negative in the other case. This distance is then divided by the size of the progressive refinement steps, rounded up and increased by one to obtain the index of the progressive step to which this grid item belongs to. If the computed index is lower than one, then the grid item belongs to the first progressive step. If the computed index is greater than the index of the ending point, then the grid item belongs to the last progressive step.

The computation of the index of the progressive step of a grid item can be summarized by the following formula:

$${i}_{G} = ⌈ \frac{\frac{\vec{{P}_{ι} G} \cdot \vec{{P}_{ι} {P}_{f}}}{‖ \vec{{P}_{ι} {P}_{f}} ‖}}{\frac{step\_numerator}{step\_denominator}} ⌉ + 1$$

Where Pᵢ is the starting point of the refinement pattern, Pf is the ending point of the refinement pattern, and G is the centre point of the grid item.

If the pattern_type value is 1, then the refinement pattern is a radial refinement pattern. A radial refinement pattern may be for example a centre-border refinement pattern.

The center_x and center_y values indicate the starting point of the radial refinement pattern, as the centre of the grid item at the given position in the grid.

Last, the step_numerator and step_denominator values indicate the size of each progressive refinement step. The step_numerator is a signed integer, allowing the size to be either positive or negative. A positive size indicates that the progressive steps go outwards from the centre of the refinement pattern while a negative size indicates that the progressive steps go inwards towards the centre of the refinement pattern.

Possibly, the step_numerator is an unsigned integer and a flag is added for signalling whether the progressive steps go outwards or inwards.

To determine to which progressive step a grid item belongs to, the following computation is realized using grid coordinates. The distance between the centre of the grid item and the centre of starting point of the radial refinement pattern is computed. This distance is divided by the value of the size, rounded up and increased by one to obtain the relative index of the progressive step to which this grid item belongs to. Once all the relative indexes for the progressive step of all the grid items have been computed, the absolute indexes are computed by subtracting to the relative indexes the value of the smallest relative index.

The computation of the index of the progressive step of a grid item can be summarized by the following formulae:

$${ri}_{G} = ⌈ \frac{‖ \vec{CG} ‖}{\frac{step\_numerator}{step\_denominator}} ⌉ + 1$$

$${i}_{G} = {ri}_{G} \pm {min}_{G} {ri}_{G}$$

Where C is the starting point of the radial refinement pattern and G is the center point of the grid item.

If the pattern_type value is 2, then the refinement pattern is a circular refinement pattern. A circular refinement pattern may be for example a clockwise refinement pattern.

The center_x and center_y values indicate the reference point of the circular refinement pattern, as the centre of the grid item at the given position in the grid.

The starting_angle value indicate the starting direction of the circular refinement pattern, where the value 0 corresponds to the direction towards the top of the image, and the starting_angle value is expressed in degrees with a clockwise orientation.

Last, the step_numerator and step_denominator values indicate the size of each progressive refinement step. The step_numerator is a signed integer, allowing the size to be either positive or negative. A positive size indicates that the progressive steps go clockwise around the reference point, while a negative size indicates that the progressive steps go counter clockwise around the reference point.

Possibly, the step_numerator is an unsigned integer and a flag is added for signalling whether the progressive steps go clockwise or counter clockwise.

To determine to which progressive step a grid item belongs to, the following computation is realized using grid coordinates. The angle between the starting direction and the vector from the reference point to the centre point of the grid item is computed. This angle is divided by the value of the size, rounded up and increased by one to obtain the relative index of the progressive step to which this grid item belongs to. Once all the relative indexes for the progressive step of all the grid items have been computed, the absolute indexes are computed by subtracting to the relative indexes the value of the smallest relative index.

The computation of the index of the progressive step of a grid item can be summarized by the following formulae:

$${ri}_{G} = ⌈ \frac{( )}{\frac{step\_numerator}{step\_denominator}} ⌉ + 1$$

$${i}_{G} = {ri}_{G} - {min}_{G} {ri}_{G}$$

Where \vec{d} is a vector corresponding to the starting direction, R is the reference point of the circular refinement pattern and G is the center point of the grid item.

Other coordinates systems may be used instead of grid coordinates. For example, pixel coordinates may be used, coordinates linked to encoding blocks may be used, or coordinates corresponding to a predefined number of pixels may be used. Possibly the horizontal unit and vertical unit may correspond to a different number of pixels.

Possibly, the values contained in the progressive refinement pattern item property may be encoded on a larger number of bits. This may be useful for example when using pixel coordinates. For example, the start_x and start_y values may be encoded on 16 or 32 bits.

Possibly, the start_x, start_y, end_x, end_y, center_x and center_y values may be encoded as signed integers to allow these points to fall outside the grid itself.

Possibly other refinement pattern types may be defined. For example, a pattern for providing a Venetian blind effect may be defined.

Possibly some flags may be added to the refinement pattern to define more precisely the position of the different points used. For example, some flags may be added to specify whether a point is in the middle of the corresponding grid item, or at one of its corner. Possibly a 2-bit flag may be used for enabling to position each point on one of the four locations of a grid item: top-left corner, centre, middle of the left border and middle of the top border.

Multiple-Level Variant

In a variant of these previously described embodiments, sub-images have more than two different versions. For example, each sub-image may have a low-quality version, a medium-quality version and a high-quality version, or even more intermediate versions.

In this variant, the same refinement pattern may be used repeatedly for describing all the transitions between the different quality levels. For example, the same refinement pattern may be used to define the progressive steps between low-quality sub-images and medium-quality sub-images and also to define the progressive steps between medium-quality sub-images and high-quality sub-images.

For example, in FIG. 4f, using a top-bottom progressive refinement pattern, there are three progressive steps corresponding to the three rows of the grid item. With three versions for each sub-image, this would result in seven progressive steps in a sequential progressive refinement of the rows: an initial progressive step with only the low-quality sub-images, followed by three progressive steps each adding the medium-quality sub-images for one row, followed by three other progressive steps each adding the high-quality sub-images for one row.

Possibly different refinement patterns may be used for describing the transitions between the different versions of the sub-images. For example, a first refinement pattern may be used to define the progressive steps between low-quality sub-images and medium-quality sub-images and a second refinement pattern may be used to define the progressive steps between medium-quality sub-images and high-quality sub-images.

For allowing several refinement patterns, the progressive refinement pattern item property may include the number of refinement patterns it contains and a loop for describing each of these patterns.

Possibly specific multi-level refinement patterns may be defined, to allow mixing the different versions of the sub-images. For example, in a centre-to-border refinement pattern, the high-quality version of the centre sub-images could be used in a progressive step before the medium-quality version of the border sub-images.

In the predefined refinement pattern variant, new multi-level refinement patterns may be defined.

Possibly, a step_offset parameter may be added to the progressive refinement pattern description, to indicate at which progressive step a new quality level for the versions of the sub-images is introduced. In the example of FIG. 4f, with a step_offset parameter with a value of 2, the high-quality sub-images for the first row are contained in the same progressive step as the medium-quality sub-images for the third row: refining the first row with the high-quality sub-images is realized 2 progressive steps after refining this first row with the medium-quality sub-images.

Possibly, a version_split_flag parameter may be added to the progressive refinement pattern description, preferably in combination with the step_offset parameter. If the value of this flag is true, then the versions of the sub-images corresponding to the new quality level are contained in the refinements of a separate progressive step, before the progressive step whose refinements contain the versions of the sub-images corresponding to the current quality level. In the example of FIG. 4f, with a step_offset parameter with a value of 2, after the progressive step whose refinements contain the medium-quality version of the second row, the next progressive step's refinements contain only the high-quality version of the first row, and is followed by another progressive step whose refinements contain the medium-quality version of the third row.

Possibly, a refinement pattern may be defined for the lowest-quality version of the sub-images. In the example of FIG. 4f, the top-bottom refinement pattern may be applied to the low-quality version of the sub-images and the first progressive step may contain only the low-quality version of the sub-images in the first row of the grid.

Incomplete Level Variant

In a variant, some versions of the sub-images may be missing. In the example of FIG. 4f, the high-quality version of the bottom-right sub-image, h9, may be missing, or the low-quality version of the bottom-left sub-image, l7, may be missing.

Possibly, these missing sub-images are just ignored. If a progressive step's refinements contain only missing sub-images, it is just skipped during the progressive rendering of the main image.

Possibly, these missing sub-images are indicated by adding a list of missing sub-images to the progressive refinement pattern item property.

Possibly, if the number of missing sub-image versions contained in the refinements of a progressive step is below a predefined threshold, then the progressive step is still considered as loaded at step 640. This threshold may be defined as a number of sub-image versions. It may also be defined as a percentage of the total number of sub-image versions contained in the refinements of the progressive step (for example, 5% or 10% of the sub-image versions). Possibly, a progressive step may be considered as loaded while some sub-image versions contained in its refinements are missing only when the elapsed time since the previous progressive step has been loaded is greater than or equal to a predefined threshold.

When generating an HEIF file using the steps of FIG. 5, the progressive specifications may include a list of sub-images that are not to be included in the resulting HEIF file.

Multi-Level Pattern

In a variant the progressive refinement order inside a progressive step may be further specified by another progressive refinement pattern. For example, a top-bottom progressive refinement pattern indicates that the progressive refinement of the main image is realized row by row. A second progressive refinement pattern may be used to indicate that inside each row, the progressive refinement starts from the centre of the row and goes towards its borders.

This second progressive refinement pattern may be specified inside the progressive refinement pattern item property, using for example the following structure:

| aligned(8) class ProgressivePatternProperty | |
|---|---|
| extends ItemFullProperty(‘ppat’, version = 0, flags = 0) { | |
| unsigned int(8) | main_pattern_type; |
| unsigned int(1) | main_reverse_flag; |
| unsigned int(1) | main_bidirectional_flag; |
| unsigned int(1) | main_parameter_flag; |
| unsigned int(5) | main_reserved; |
| unsigned int(8) | main_scale; |
| if (parameter_flag == 1) { | |
| unsigned int(32) | main_parameter; |
| } | |
| unsigned int(8) | secondary_pattern_type; |
| unsigned int(1) | secondary_reverse_flag; |
| unsigned int(1) | secondary_bidirectional_flag; |
| unsigned int(1) | secondary_parameter_flag; |
| unsigned int(5) | secondary_reserved; |
| unsigned int(8) | secondary_scale; |
| if (parameter_flag == 1) { | |
| unsigned int(32) | secondary_parameter; |

}
}

Several second progressive refinement patterns may be specified for the different progressive steps.

The second progressive refinement patterns may have a different structure than the main progressive refinement patterns.

Offset Embodiment

In a second embodiment of the invention, hereinafter called the offset embodiment, the progressive steps are indicated using positions in the HEIF file.

Advantageously, this second embodiment provides an explicit and simple indication of the progressive steps for an HEIF file.

Some information about these progressive steps may be exposed at the application level, allowing an application to select an HEIF file among several based on its number of progressive steps.

Step Location Variant

In a first variant of this second embodiment, the step location variant, for each progressive step, the location of the last byte in the HEIF file that is part of the last sub-image version contained in this progressive step's refinements is specified in the progressive information stored in the HEIF file.

The positions of the progressive steps for an image item inside the HEIF file may be indicated with an item property associated with this image item. This progressive step location item property may be described by the following structure:

| aligned(8) class ProgressiveStepLocationProperty | |
|---|---|
| extends ItemFullProperty(‘ploc’, version = 0, flags = 0) { | |
| unsigned int(16) | step_count; |
| for (i=0; i < step_count; i++) { | |
| if (flags & 1) { | |
| unsigned int(32) | item_index; |
| } | |
| else { | |
| unsigned int(16) | item_index; |
| } | |
| unsigned int(16) | extent_index; |

}
}

Different sizes may be used for the fields of this progressive step location item property. Possibly some flags, either using the flags parameter for the ItemFullProperty or flag values directly encoded inside the progressive step location item property, may be used to specify the size of the different fields.

In this structure, the step_count indicates the number of progressive steps described inside the progressive step location item property.

For each progressive step, the item_index value indicates the index of a resource inside the array in the item location box, ‘iloc’. The extent_index value indicates the index of an extent for this resource. The location of the progressive step is the last byte of this indicated extent.

Possibly the extent_index is an optional field. If it is not present, then the location of the progressive step is the last byte of the last extent of the item indicated by the item_index value.

Possibly the progressive step location item property doesn't contain an extent_index field.

In this embodiment, in step 510 of FIG. 5, the progressive specifications include some information for defining the progressive steps. This information may include for example the list of sub-image versions contained in each progressive step refinements.

In this embodiment the ordering of step 520 and step 530 is switched.

First, the ordering of the progressive data blocks is realized in step 530 using the definition of the progressive steps. Using this ordering, the structure of the HEIF file is created and the content of the ‘iloc’ box is generated.

Then, step 520 is executed, generating a progressive step location item property based on the content of the ‘iloc’ box and the definition of the progressive steps. This item property is written as a part of the ‘meta’ box of the HEIF file at step 540 and is associated with the image item corresponding to the main image in the HEIF file. For instance, the item property structure is written as part of the item property container box ‘ipco’ and is associated with the image item corresponding to the main image via an item property association box ‘ipma’.

In this embodiment, in step 620 of FIG. 6, the progressive information is extracted by parsing the progressive step location item property. This progressive information is used to generate the list of progressive steps for the main image. Each progressive step is specified by its location that is the last byte of the extent indicated in the progressive step location item property.

Possibly, if the extent index field is not present, the location of the progressive step is the last byte of the last extent of the item indicated in the progressive step location item property.

At step 640, the location of the progressive steps is compared to the last loaded byte of the HEIF file. If the location of the progressive step is before the position of the last loaded byte, then the progressive step has been loaded.

If the progressive steps are ordered according to their location, only the first progressive step not already loaded needs to be checked at step 640.

Preferably, the progressive steps are ordered in the progressive step location item property according to their location order inside the HEIF file. If this is not the case, the progressive steps can be reordered according to their location after having been extracted from the progressive step location item property.

Possibly in this variant, an item may be identified by its identifier instead of its index inside the array in the item location box.

Step Refinement Variant

In a second variant, the step refinement variant, each progressive step is specified by the list of the extents containing data for the sub-image versions contained in the progressive step's refinements.

The lists of extents composing the different progressive steps' refinements of an image item may be indicated with an item property associated with this image item. This progressive step refinement item property may be described by the following structure:

| aligned(8) class ProgressiveStepRefinementProperty | |
|---|---|
| extends ItemFullProperty(‘prco’, version = 0, flags = 0) { | |
| unsigned int(16) | step_count; |
| for (i=0; i < step_count; i++) { | |
| unsigned int(16) | item_count; |
| for (j=0; j < item_count; j++) { | |
| if (flags & 1) { | |
| unsigned int(32) | item_index; |
| } | |
| else { | |
| unsigned int(16) | item_index; |
| } | |
| unsigned int(16) | extent_count; |
| for (k=0; k < extent_count; k++) { | |
| unsigned int(16) | extent_index; |

```
      }
    }
  }
}
```

Different sizes may be used for the fields of this progressive step refinement item property. Possibly some flags, either using the flags parameter for the ItemFullProperty or flag values directly encoded inside the progressive step refinement item property, may be used to specify the size of the different fields.

In this structure, the step_count indicates the number of progressive steps described inside the progressive step refinement item property.

For each progressive step, the item_count value indicates how many items are comprised in the progressive step' refinements. For each item, the item_index value indicates the index of a resource inside the array in the item location box, ‘iloc’.

For each item, the extent_count value indicates how many extents are comprised in the progressive step's refinements for this item. For each extent, the extent index value indicates the index of an extent for this resource.

The generation of an HEIF file using this variant is similar to the one for the ‘iloc’ references.

In this variant, in step 620 of FIG. 6, each progressive step is specified by the list of extents that are part of its refinements.

At step 640, it is checked whether all the extents belonging to the refinements of the progressive step have been loaded.

This variant may be relevant for image items that are split into spatial parts like tiles or sub-pictures or even layers, where each spatial part has its data identified by an extent in the ‘iloc’ box.

Possibly in this variant, an item may be identified by its identifier instead of its index inside the array in the item location box.

Possibly, the progressive step refinement item property is described by the following structure:

| aligned(8) class ProgressiveStepRefinementProperty | |
|---|---|
| extends ItemFullProperty(‘prco’, version = 0, flags = 0) { | |
| unsigned int(16) | step_count; |
| for (i=0; i < step_count; i++) { | |
| unsigned int(16) | item_count; |
| for (j=0; j < item_count; j++) { | |
| if (flags & 1) { | |
| unsigned int(32) | item_index; |
| } | |
| else { | |
| unsigned int(16) | item_index; |
| } | |
| unsigned int(16) | extent_count; |

```
    }
  }
}
```

In this variant, the extent_count value indicates how many extents for the item are comprised in the progressive step's refinements or in previous progressive steps' refinements. In this variant, for an item, extents are organized in decoding order.

Possibly, the extents that are part of the progressive step's refinements are computed by comparing the list of extents specified for this progressive step in the progressive step refinement item property with the extents present in previous progressive steps' refinements. These extents are used at step 640 to check whether the progressive step has been loaded.

Possibly, the check of step 640 is modified to check whether all the extents specified for this progressive step in the progressive step refinement item property have been loaded.

Possibly, in this variant, the extent_count field is optional. If it is absent, all the extents for the item are comprised in the progressive step's refinements or in previous progressive steps' refinements.

In a variant, the specification of a progressive step may use pointers into the HEIF file. This variant may be used either with the step location variant or with the step refinement variant.

Possibly, these pointers may be absolute offsets into the HEIF file.

For example, with the step location variant, for each progressive step, the location of the last byte that is part of a sub-image version contained in this progressive step is specified directly as an offset into the HEIF file.

As another example, with the step refinement variant, for each progressive step, the locations of the sub-image versions contained in the progressive step refinements is specified as a list of offsets into the HEIF file, each offset being associated with a length.

Possibly, these pointers may be specified using a mechanism similar to the one used by the Item Location Box. Possibly, only part of the mechanism used by the Item Location Box may be used. For example, these pointers may be specified as offset into the ItemDataBox ‘idat’ or into the IdentifiedMediaDataBox ‘imda’.

‘iloc’-Based Variant

In a variant, the specification of a progressive step is realized in a new version of the Item Location Box.

In this variant, a flag is added to each extent to indicate whether the last byte of this extent is the last byte of a sub-image version contained in a progressive step refinements. In this way, the progressive steps may be reconstructed from the information contained in the Item Location Box. This flag may be named progressive_step_end.

Possibly, this flag may be added to each item instead of to each extent.

Possibly, a progressive step number field is added to each extent to indicate into which progressive step's refinements this extent is contained. The value 0 may be reserved to indicate that the extent is not contained in any progressive step's refinements. This progressive step number field may be named progressive_step_number. Possibly a flag may be used to indicate the presence of this field.

Possibly, a progressive step number end field is added to each extent to indicate that the last byte of this extent is the last byte of a sub-image version contained in the corresponding progressive step's refinements. The value 0 may be reserved to indicate that the last byte of the extent is not the last byte of a sub-image version contained in a progressive step's refinements. This progressive step number field may be named progressive_step_number_end. Possibly a flag may be used to indicate the presence of this field.

Item Embodiment

In a third embodiment of the invention, hereinafter called the item embodiment, the progressive steps are indicated using indications of the sub-image versions they contain in their refinements.

Advantageously, this third embodiment provides a simple link between the sub-images composing a main image and the progressive steps for this main image.

Advantageously some variants of this third embodiment require only a minimal signalization in the HEIF file.

In a first variant of this third embodiment, hereinafter called the version list variant, for each progressive step, the list of sub-image versions contained in this progressive step's refinements is specified in the progressive information stored in the HEIF file.

The sub-image versions contained in the progressive steps' refinements for an image item inside the HEIF file may be indicated with an item property associated with this image item. This progressive version list item property may be described by the following structure:

| aligned(8) class ProgressiveVersionListProperty | |
|---|---|
| extends ItemFullProperty(‘pvli’, version = 0, flags = 0) { | |
| unsigned int(16) | step_count; |
| for (i=0; i < step_count; i++) { | |
| unsigned int(16) | item_count; |
| for (j=0; j < item_count; j++) { | |
| if (flags & 1) { | |
| unsigned int(32) | item_ID; |
| } | |
| else { | |
| unsigned int(16) | item_ID; |

```
      }
    }
  }
}
```

In this structure, the step_count indicates the number of progressive steps described inside the progressive version list item property.

For each progressive step, the item_count value indicates the number of sub-image versions contained in this progressive step's refinements.

For each sub-image version, the item_ID value indicates the identifier of the image item corresponding to this sub-image version.

In this embodiment, in step 510 of FIG. 5, the progressive specifications include some information for defining the progressive steps. This information may include for example the list of sub-image versions contained in each progressive step's refinements.

In step 520 of FIG. 5, a progressive version list item property is generated based on the definition of the progressive steps. This item property is written as a part of the ‘meta’ box of the HEIF file at step 540 and is associated with the image item corresponding to the main image in the HEIF file. For instance, the item property structure is written as part of the item property container box ‘ipco’ and is associated with the image item corresponding to the main image via an item property association box ‘ipma’.

In this embodiment, in step 620 of FIG. 6, the progressive information is extracted by parsing the progressive version list item property. This progressive information is used to generate the list of progressive steps for the main image. Each progressive step is specified by the list of sub-image versions it contains in its refinements.

At step 640, it is checked whether all the data for the image items specified in the list of sub-image versions contained in a progressive step's refinements have already been loaded.

Possibly, a sub-image may be encoded as a multi-layer image described by a single image item. The different versions of the sub-image are encoded as different layers of this image item. In this case, all the versions of the sub-image may be described by a single image item. The progressive version list item property may be modified to indicate the encoding layer corresponding to a version of a sub-image. This modified progressive version list item property may be described by the following structure:

| aligned(8) class ProgressiveVersionListProperty | |
|---|---|
| extends ItemFullProperty(‘pvli’, version = 0, flags = 0) { | |
| unsigned int(16) | step_count; |
| for (i=0; i < step_count; i++) { | |
| unsigned int(16) | item_count; |
| for (j=0; j < item_count; j++) { | |
| if (flags & 1) { | |
| unsigned int(32) | item_ID; |
| } | |
| else { | |
| unsigned int(16) | item_ID; |
| } | |
| unsigned int(1) | has_layer; |
| if (has_layer == 1) { | |
| unsigned int(15) | layer_id; |
| } else { | |
| unsigned int(7) | reserved; |

```
      }
    }
  }
}
```

In this structure, the has_layer value is a flag indicating whether the version of the sub-image corresponds to a specific encoding layer of the image item with the given item_ID. If the value of this has_layer flag is true, the layer_id value indicates the identifier of the encoding layer corresponding to the version of the sub-image.

Possibly, the different layers contained in an image item corresponding to a sub-image may be described by an item property associated to this image item. This progressive layer item property may be described by the following structure:

| aligned(8) class ProgressiveLayerProperty | |
|---|---|
| extends ItemFullProperty(‘play’, version = 0, flags = 0) { | |
| unsigned int(8) | layer_count; |
| for (i=0; i < layer_count; i++) { | |
| unsigned int(16) | layer_id; |

}
}

In this structure, the layer count value indicates the number of layers used for the progressive rendering. The total number of layers present in the image item may be greater than this indicated number of layers.

For each layer, the layer_id value indicates the identifier of this layer.

The progressive version list item property structure may be modified to take advantage of this progressive layer item property:

| aligned(8) class ProgressiveVersionListProperty | |
|---|---|
| extends ItemFullProperty(‘pvli’, version = 0, flags = 0) { | |
| unsigned int(16) | step_count; |
| for (i=0; i < step_count; i++) { | |
| unsigned int(16) | item_count; |
| for (j=0; j < item_count; j++) { | |
| if (flags & 1) { | |
| unsigned int(32) | item_ID; |
| } | |
| else { | |
| unsigned int(16) | item_ID; |
| } | |
| unsigned int(8) | layer_index; |

```
    }
  }
}
```

In this structure, the layer_index value indicates the 1-based index of the layer inside the progressive layer item property associated to the image item corresponding to the sub-image version and specified by the value of item_ID. The value 0 is reserved for indicating that the sub-image version corresponds to the full content of the image item.

Possibly, the progressive layer item property may be replaced by several ‘lsel’ layer selection item properties, each ‘lsel’ layer selection item property indicating one of the layer contained in the image item. In this case, the layer_index value indicates the 1-based index of the ‘lsel’ item property that is associated to the image item corresponding to the sub-image and specified by the value of item_ID and that indicates the layer corresponding to the sub-image version.

For these two variants, at step 640 of FIG. 6, it is checked for each image item specified in the list of sub-image versions contained in a progressive step's refinements whether the corresponding sub-image version has been loaded. If there is no layer identifier specified for this image item and the whole data for this image item have been loaded, then the corresponding sub-image version has been loaded. If there is a layer identifier specified for this image item and the data for this layer and for all the previous layers have been loaded, then the corresponding sub-image version has been loaded.

Possibly, the identifiers for the sub-image version's items are allocated in the progressive refinement order. The progressive version list item property may be described by the following structure:

| aligned(8) class ProgressiveVersionListProperty | |
|---|---|
| extends ItemFullProperty(‘pvli’, version = 0, flags = 0) { | |
| unsigned int(16) | step_count; |
| for (i=0; i < step_count; i++) { | |
| if (flags & 1) { | |
| unsigned int(32) | item_ID; |
| } | |
| else { | |
| unsigned int(16) | item_ID; |

```
    }
  }
}
```

In this structure, the item_ID value indicates the identifier of the last image item corresponding to a sub-image version contained in the refinements of the progressive step.

Item List Variant

In a second variant of this third embodiment, the item list variant, for each progressive step, the list of sub-images for which a version is contained in this progressive step's refinements is specified in the progressive information stored in the HEIF file.

While the first variant indicates explicitly the sub-image versions contained in the refinements of a progressive step, this second variant indicates only the sub-images for which a version is contained in the refinements of a progressive step. This means that the renderer has to determine for each sub-image indicated in relation to a progressive step which of the sub-image versions is contained in the refinements of this progressive step.

The sub-images for which a version is contained in the progressive steps' refinements for an image item inside the HEIF file may be indicated with an item property associated with this image item. This progressive item list item property may be described by the following structure:

```
aligned(8) class ProgressiveItemListProperty
extends ItemFullProperty(‘pili’, version = 0, flags = 0) {
  unsigned int(16) step_count;
  for (i=0; i < step_count; i++) {
    unsigned int(16) item_count;
    for (j=0; j < item_count; j++) {
      if (flags & 1) {
        unsigned int(32) item_ID;
      }
      else {
        unsigned int(16) item_ID;
      }
    }
  }
}
```

In this structure, the step_count indicates the number of progressive steps described inside the progressive item list item property.

For each progressive step, the item_count value indicates the number of sub-images for which a version is contained in this progressive step's refinements.

For each sub-image, the item_ID value indicates the identifier of the image item for which a version is contained in this progressive step's refinements.

In this embodiment, in step 510 of FIG. 5, the progressive specifications include some information for defining the progressive steps. This information may include for example the list of sub-image versions contained in each progressive step's refinements.

In step 520 of FIG. 5, a progressive item list item property is generated based on the definition of the progressive steps. This item property is written as a part of the ‘meta’ box of the HEIF file at step 540 and is associated with the image item corresponding to the main image in the HEIF file. For instance, the item property structure is written as part of the item property container box ‘ipco’ and is associated with the image item corresponding to the main image via an item property association box ‘ipma’.

Preferably, for each sub-image that is a component of the main image, the list of its versions is explicitly included as a part of the ‘meta’ box of the HEIF file. If the versions are based on encoding layers of the sub-image, then a progressive layer item property or a set of layer selection item properties, ‘lsel’, may be used to list the versions of this sub-image. Otherwise, an ‘altr’ entity group may be used to list all the image items corresponding to versions of this sub-image. The highest-quality version of the sub-image should be listed first in this ‘altr’ entity group.

In this embodiment, in step 620 of FIG. 6, the progressive information is extracted by parsing the progressive item list item property. This progressive information is used to generate the list of progressive steps for the main image. Each progressive step is specified by the list of sub-images for which a version is contained in the progressive step's refinements.

At step 640, it is checked whether a new version is available for all the sub-images contained in the list associated to a progressive step.

As a variant, in step 620, the list of versions for each sub-image may be computed. Preferably, this list of versions is extracted from an explicit description in the HEIF file. If a sub-image version is an image item referenced by an ‘altr’ entity group, then the list of all versions of the sub-image is the list of image items contained in this ‘altr’ entity group. If a sub-image version is an image item with an associated progressive layer item property, then the list of all versions of the sub-image is the list of encoding layers indicated in this progressive layer item property. If a sub-image version is an image item referenced by an ‘altr’ entity group and with an associated progressive layer item property, then the list of all versions of the sub-image is the combination of the lists for both cases.

Possibly, the list of versions for a sub-image is inferred from other structures from the ‘meta’ box of the HEIF file. For example, if a sub-image version is an image item that is associated with a thumbnail, then this thumbnail is a version of the sub-image.

Once this list of versions for each sub-image has been computed, these versions are ordered in a progressive refinement order, from the lowest quality to the highest quality and associated to the progressive step. For each sub-image, its versions are associated in order to the progressive steps that list this sub-image.

In this variant, at step 640, it is checked whether all the sub-image versions contained in a progressive step's refinements have already been loaded. If a sub-image version corresponds to an encoding layer of a multi-layer image item, then it is checked whether the data for this encoding layer and for all the previous encoding layers have been loaded. Otherwise, it is checked whether the data for the image item have been loaded.

Item Reference Variant

A third variant of this third embodiment, hereinafter called the item reference variant, is similar to the second variant. Instead of storing the list of sub-images for which a version is contained in a progressive step's refinements in an item property, this list is stored in an entry of the Item Reference Box.

The Item Reference Box entry may have the ‘prli’ 4cc. The from_item_ID field of the entry is the identifier of the main image and the sub-images are specified using the to_item_ID fields of the entry. This reference type indicates for a main image the list of image items that are contained in the refinements of a progressive step. There is an Item Reference Box entry of type ‘prli’ for each progressive step and these entries are ordered according to the progressive steps order.

Item Count Variant

In a fourth variant of this third embodiment, hereinafter called the item count variant, for each progressive step, the number of sub-image versions contained in this progressive step's refinements is specified in the progressive information stored in the HEIF file.

This number of sub-image versions contained in the progressive step's refinements for an image item inside the HEIF file may be indicated with an item property associated with this image item. This progressive item count item property may be described by the following structure:

```
aligned(8) class ProgressiveItemCountProperty
extends ItemFullProperty(‘pcnt’, version = 0, flags = 0) {
  unsigned int(16) step_count;
  for (i=0; i < step_count; i++) {
    unsigned int(16) item_count;
  }
}
```

In this structure, the step_count indicates the number of progressive steps described inside the progressive item count item property.

For each progressive step, the item_count value indicates the number of sub-images for which a version is contained in this progressive step's refinements.

In this embodiment, in step 510 of FIG. 5, the progressive specifications include some information for defining the progressive steps. This information may include for example the number of sub-image versions contained in each progressive step's refinements.

In step 520 of FIG. 5, a progressive item count item property is generated based on the definition of the progressive steps. This item property is written as a part of the ‘meta’ box of the HEIF file at step 540 and is associated with the image item corresponding to the main image in the HEIF file. For instance, the item property structure is written as part of the item property container box ‘ipco’ and is associated with the image item corresponding to the main image via an item property association box ‘ipma’.

Preferably, for each sub-image that composes the main image, the list of its versions is explicitly included as a part of the ‘meta’ box of the HEIF file. If the versions are based on encoding layers of the multi-layer sub-image, then a progressive layer item property may be used to list the versions of this multi-layer sub-image. Otherwise, an ‘altr’ entity group may be used to list all the image items corresponding to versions of this sub-image. The highest-quality version of the sub-image should be listed first in this ‘altr’ entity group.

At step 640, the number of sub-images for which a new version has been loaded since the previous progressive step is counted. Then it is checked whether this number is greater than or equal to the number associated with the current progressive step.

As a variant, in step 620, the list of versions for each sub-image may be computed. Preferably, this list of versions is extracted from an explicit description in the HEIF file. If a sub-image version is an image item referenced by an ‘altr’ entity group, then the list of all versions of the sub-image is the list of image items contained in this ‘altr’ entity group. If a sub-image version is an image item with an associated progressive layer item property, then the list of all versions of the sub-image is the list of encoding layers indicated in this progressive layer item property. If a sub-image version is an image item referenced by an ‘altr’ entity group and with an associated progressive layer item property, then the list of all versions of the sub-image is the combination of the lists for both cases.

Possibly, the list of versions for a sub-image is inferred from other structures of the ‘meta’ box of the HEIF file. For example, if a sub-image version is an image item that is associated with a thumbnail, then this thumbnail is a version of the sub-image.

Once this list of versions for each sub-image has been computed, these versions are ordered in a progressive refinement order, from the lowest quality to the highest quality and associated to the progressive step. For each sub-image, its versions are associated in order to the progressive steps that list this sub-image.

In this variant, at step 640, it is checked whether all the sub-image versions contained in a progressive step's refinements have already been loaded. If a sub-image version corresponds to an encoding layer of a multi-layer image item, then it is checked whether the data for this encoding layer and for all the previous encoding layers have been loaded. Otherwise, it is checked whether the data for the image item have been loaded.

In a variant instead of storing the number of sub-image versions contained in a progressive step's refinements, the number of sub-image versions contained in the progressive step's content is stored. In this variant, at step 640, the total number of sub-image versions loaded is counted and compared to the number associated with the progressive step.

In a variant, a single item_count value is used for all the progressive steps. In this variant, the progressive item count item property may be described by the following structure:

aligned(8) class ProgressiveItemCountProperty
extends ItemFullProperty(‘pcnt’, version = 0, flags = 0) {
unsigned int(16) item_count;
}

In another variant, the number of sub-images for which a version is contained in a progressive step's refinements is specified as a percentage of the total number of sub-image versions. Possibly, this total number doesn't take into account the low-quality sub-image versions.

Item Step Embodiment

In a fourth embodiment of the invention, hereinafter called the item step embodiment, the progressive steps are indicated using indications of the sub-image versions they contain in their refinements, each sub-image version being indicated as a progressive step of the sub-image.

Advantageously, this fourth embodiment uses the same mechanisms for describing the progressive steps of the derived image and the different versions of a sub-image.

In a first variant of this embodiment, for each progressive step, the list of sub-image versions contained in this progressive step's refinements is specified in the progressive information stored in the HEIF file.

The sub-image versions contained in the progressive step's refinements for an image item inside the HEIF file may be indicated with an item property associated with this image item. This progressive derived information item property may be described by the following structure:

```
aligned(8) class ProgressiveDerivedInformationProperty
extends ItemFullProperty(‘prdi’, version = 0, flags = 0) {
  unsigned int(8) step_count;
  for (i=0; i < step_count; i++) {
    unsigned int(8) item_count;
    for (j=0; j < item_count; j++) {
      unsigned int(16) input_item_index;
      unsigned int(1) has_steps;
      unsigned int(7) reserved;
      if (has_steps) {
        unsigned int(8) step_index;
      }
    }
  }
}
```

In this structure, the step_count indicates the number of progressive steps described inside the progressive derived information item property for the associated derived image item.

For each progressive step, the item_count value indicates the number of sub-image versions contained in this progressive step's refinements.

For each sub-image version, the input_item_index value indicates an identifier of the sub-image item corresponding to this sub-image version as the index of the sub-image inside the list of input images used to build the derived image item. The list of input images is provided by the ‘dimg’ item reference from the derived item.

For each sub-image version, the has_steps flag indicates whether the input image item indicated by the input_item_index has one or more versions described as progressive steps. If the input image item has associated progressive steps, then the has_steps flag has the value 1, otherwise it has the value 0. Possibly, if the input image item has only a single progressive step, i.e., the input image itself, then the has_steps flag may have the value 0. Preferably, the index is 0-based, with the value 0 corresponding to the first progressive step of the input image.

If the has_steps flag has the value 1, then the step_index value is the 0-based index of the progressive step of the input image item corresponding to the version of the sub-image to use for building the progressive step of the derived item.

The progressive steps for the input image item may be signalled using an entity group of type ‘altr’. An entity group of type ‘altr’ may be used to group alternative versions of an input image item. In this case, the index associated to a progressive step of an input image item is its position inside the entity group of type ‘altr’.

Preferably, the progressive steps for the input image item are signalled using a more specific entity group type dedicated to this task, for example an entity group of type ‘prgr’ (for progressive entity group). The entity group of type ‘prgr’ will be used hereafter in a non-restrictive manner to describe any entity group used for signalling progressive steps for an item as a list of items.

Inside a ‘prgr’ entity group, the input image item versions are preferably listed in increasing quality order. Preferably the ordering of the data corresponding to these input image item versions matches the ordering inside the entity group. Any image item contained in a ‘prgr’ entity group may be used as a replacement for another image item contained in the same ‘prgr’ entity group, in particular for realizing a progressive rendering of one of the image item contained in the entity group. Preferably, during the progressive rendering of an image item contained in a ‘prgr’ entity group, image item occurring before it inside the entity group are rendered as a temporary replacement. Consequently, the different image items contained in a ‘prgr’ entity group preferably correspond to similar images but with different quality levels and/or resolutions.

An input image item for a derived item may be the last item inside the entity group of type ‘prgr’ associated to this input image item. This input image item may also not be the last item inside this entity group. For example, the entity group may include a thumbnail of the input image item, the input image item itself as a low dynamic range image (LDR) and a high dynamic range version (HDR) of the input image. This entity group also signals that the thumbnail and the LDR image item may be used for the progressive rendering of the HDR input image. Preferably, if the input image item is not the last item inside the entity group of type ‘prgr’, then items occurring after it inside the entity group of type ‘prgr’ are not considered as versions for this input image item.

In this embodiment, in step 510 of FIG. 5, the progressive specifications include some information for defining the progressive steps. This information may include for example the list of sub-image versions contained in each progressive step's refinements.

In step 520 of FIG. 5, a progressive derived information item property is generated based on the definition of the progressive steps. This item property is written as a part of the ‘meta’ box of the HEIF file at step 540 and is associated with the image item corresponding to the derived image in the HEIF file. For instance, the item property structure is written as part of the item property container box ‘ipco’ and is associated with the image item corresponding to the derived image via an item property association box ‘ipma’.

Furthermore, for each input image item associated to the derived image item that has several versions based on the definition of the progressive steps, an entity group of type ‘prgr’ is generated to group these image item versions in increasing quality order.

In this embodiment, in step 610, the structures extracted from the ‘meta’ box also include the entity groups.

At step 620, the progressive information is extracted from the derived information item properties and from the ‘prgr’ entity groups.

At step 640, it is checked whether all the data for the image versions specified in the list of sub-image versions contained in a progressive step's refinements have already been loaded.

Possibly, the derived image item itself is contained in an entity group of type ‘prgr’ for indicating progressive steps based on other image items in addition to those based on different input image versions. For example, a grid item may be included in an entity group of type ‘prgr’ with a thumbnail and a preview and an item property of type ‘prdi’ may be associated with the grid item. In this case, the progressive display of the grid may start with the thumbnail, followed by the preview and then by all the progressive steps described in the ‘prdi’ item property. Possibly not all these progressive steps are used during the rendering of the derived item.

Possibly, one or more of the initial progressive steps described in the ‘prdi’ item property may not include versions for all the sub-image items used by the derived item. In this case, the rendering of the derived item may generate a partial result for the derived item. The rendering may replace sub-image items without any version with a blank image, or with a transparent image. For example, the first progressive step described in the ‘prdi’ item property may only include sub-image items corresponding to the top row of a grid item. Then, this partial result may be the top row of the grid item. Possibly, if an entity group of type ‘prgr’ contains the derived item, the renderer may combine another image item with the partial result to provide a complete rendering of the derived item albeit with a variable quality. In the previous example, the renderer may combine the top row of the grid item with the thumbnail of the grid item to generate a complete image where the top row has a good quality and the remaining rows have a low quality.

Possibly, the has_steps flag may not be present. In this case, the value of step_index field indicates the index of the progressive step plus one. The value 0 is used to indicate that there are no progressive steps associated to the input image. Possibly, the value 0 is used to indicate either that there are no progressive steps associated to the input image and that the input image itself should be used as the input image version, or that there are progressive steps associated to the input image and that the first progressive step should be used as the input image version.

In a second variant of this embodiment, the progressive derived item information item property may also indicate a layer for an input image item with the following structure:

```
aligned(8) class ProgressiveDerivedInformationProperty
extends ItemFullProperty(‘prdi’, version = 0, flags = 0) {
  unsigned int(8) step_count;
  for (i=0; i < step_count; i++) {
    unsigned int(8) item_count;
    for (j=0; j < item_count; j++) {
      unsigned int(16) input_item_index;
      unsigned int(1) has_steps;
      unsigned int(1) has_layers;
      unsigned int(6) reserved;
      if (has_steps) {
        unsigned int(8) step_index;
      }
      if (has_layers) {
        unsigned int(8) layer_index;
      }
    }
  }
}
```

In this structure, the has_layers flag indicates whether the input image item indicated by the input_item_index has one or more versions described as layers. If the input image item has one or more versions described as layers, then the has_layers flag has the value 1, otherwise it has the value 0. Possibly, if the input image item has only one layer corresponding to the whole input image, then the has_layers flag may have the value 0. Preferably, the index is 0-based, the value 0 corresponding to the first layer of the input image item.

If the has_layers flag has the value 1, then the layer_index value is the 0-based index of the layer, or set of layers, of the input image item to use for building the progressive step of the derived item.

The layers of the input image item may be described using a ‘play’ progressive layer item property, or several ‘lsel’ layer selection item properties, or any similar property describing the layers composing an input image item. Possibly the layers of the input image item may be described using a ‘liip’ item property with the following structure:

```
class LayeredImageIndexingProperty
extends ItemFullProperty(‘liip’, version = 0, flags) {
  field_length = ((flags & 1) + 1) * 16;
  unsigned int(field_length) [4] layer_size;
}
```

The ‘liip’ 4cc used here is an example of 4cc for the layered image indexing property and any other 4cc not conflicting with existing 4cc may be used.

The ‘liip’ item property describes the layers of the associated image item by giving their sizes in the image item data.

The layer_size field indicates the number of bytes corresponding to each layer in the item payload. Possibly, this field may be replaced by an offset value in bytes, either in the item payload, or in the box containing the item payload, or in the HEIF file itself.

Possibly, the encoding size of the layer_size may be a constant, for example 32 bits. In this case, the field_length value is not computed.

Possibly, the item property for indicating layers for a progressive rendering may have a different name, for example ProgressiveLayerInformationProperty with the associated ‘plai’ 4cc. Possibly, the ‘plai’ progressive layer information item property may indicate only some of the layers of the image item to which it is associated: those used for a progressive rendering of the image item. As a variant, the ‘plai’ item property may use the ‘prli’ 4cc. The ‘plai’ item property will be used hereafter in a non-restrictive manner to describe any item property associated with an image item to signal layers used as progressive steps for this image item. In addition, except where noted, the ‘plai’ item property may be replaced by a more generic item property associated with the image item to signal layers used in the encoding for this image item, such as a ‘liip’ item property.

The progressive layer information item property may have the following structure:

```
class ProgressiveLayerInformationProperty
extends ItemFullProperty (‘plai’, version = 0, flags) {
  field_length = ((flags & 1) + 1) * 16;
  unsigned int(8) step_count;
  for (i=0; i < step_count; i++) {
    unsigned int(field_length) step_size;
  }
}
```

The step_count field indicates the number of progressive steps described by the progressive layer information property.

The step_size field indicates the number of bytes corresponding to each progressive step in the item payload.

Possibly, the size for the last progressive step may be omitted or set to the 0 value for reducing the size of the progressive layer information item property.

Possibly an image item with an associated ‘plai’ item property may also be contained in a ‘prgr’ entity group.

Preferably an image item has not both an associated ‘prdi’ item property and an associated ‘plai’ item property as these item properties correspond to different kind of image items.

The entity group of type ‘prgr’ will be used hereafter in a non-restrictive manner to describe any entity group used for signalling progressive steps for an item as a list of items.

For this variant, at step 520 of FIG. 5, a progressive layer information item property, ‘plai’, is generated for each input image item for which several layers are used as progressive steps.

For this variant, at step 640 of FIG. 6, it is checked for each image item specified in the list of sub-image versions contained in a progressive step's refinements whether the corresponding sub-image version has been loaded. If there is no layer identifier specified for this image item, for example through a ‘plai’ item property, and the whole data for this image item have been loaded, then the corresponding sub-image version has been loaded. If there is a layer identifier specified for this image item and the data for this layer and for all the previous layers have been loaded, then the corresponding sub-image version has been loaded.

Possibly, the has_layers flag may not be present. In this case, the value of layer_index field indicates the index of the layer plus one. The value 0 is used to indicate there is no layer associated to the input image item. Possibly, the value 0 is used to indicate either that there is no layer associated to the input image item and that the whole input image item should be used as the input image item version, or that there are layers associated to the input image item and that the first layer should be used as the input image item version.

Possibly, the layer_index field may be replaced by an offset value in bytes corresponding to the position at the end of the data corresponding to the indicated layer, Possibly, the layer_index field may be replaced by the size of all the layers used to generate the indicated version of the input item. In these two latter variants, when the has_layers flag is not present, the value 0 may be used to indicate that the input image has no layers and the input image is the whole input image.

In this second variant of this embodiment, by removing the has_steps and has_layers flags, the progressive derived item information item property may be simplified resulting in the following structure:

```
aligned(8) class ProgressiveDerivedInformationProperty
extends ItemFullProperty(‘prdi’, version = 0, flags = 0) {
  unsigned int(8) step_count;
  for (i=0; i < step_count; i++) {
    unsigned int(8) item_count;
    for (j=0; j < item_count; j++) {
      unsigned int(16) input_item_index;
      unsigned int(8) step_index;
      unsigned int(8) layer_index;
    }
  }
}
```

This structure describes the progressive rendering steps associated with a derived image item. Each progressive step may be seen as specifying replacement images to use in place of the input images used by the derived image item. A seen before, a replacement image is a version of an input image and may be an empty image, a lower-quality version of the input image, or the input image itself.

In this structure, each progressive rendering step is described as a difference from the previous step. This description lists replacement images, or versions of the input images, to be used to reconstruct the derived image item. Initially, before the first progressive rendering step, replacement images for input images all correspond to empty images. Each progressive rendering step adds new images as replacement images and/or updates existing replacement images with other replacement images.

This structure may describe two different cases of replacement images, or versions of input images. First, an input image may be replaced by a lower-quality image associated to it by being contained in the same ‘prgr’ entity group. Second, an input image may be replaced by a lower-quality version corresponding to some of layers composing this input image and described through an associated ‘plai’ item property. Possibly. The input image may be both contained in a ‘prgr’ entity group and have an associated ‘plai’ item property.

Using this structure, if an input image is not contained in a ‘prgr’ entity group, then the step_index field is set to the value 0. If the input image is contained in a ‘prgr’ entity group, then the step_index value is the 0-based index inside the ‘prgr’ entity group of the image item to use as a replacement for this input image.

Using this structure, if an input image has no associated ‘plai’ item property, then the layer_index field is set to the value 0. If the input image has an associated ‘plai’ item property, then the layer_index value is the 0-based index inside the associated ‘plai’ item property of the set of layers to use as a replacement for this input image.

Using this structure, if an input image is neither contained in a ‘prgr’ entity group nor associated with a ‘plai’ item property, then both the step_index and the layer_index fields have the value 0.

Using this structure, if an input image is both contained in a ‘prgr’ entity group and associated with a ‘plai’ item property, the information inside the ‘plai’ item property as indicated by the layer_index field is taken into account only if the step_index corresponds to the position of the input image inside the ‘prgr’ entity group. Otherwise, the layer_index is set to 0 and the information inside the ‘plai’ item property is ignored.

Possibly, in this structure, the input_item_index, may have a different name, for example item_index.

Possibly in either the first or second variant of this embodiment, or where applicable elsewhere, the meaning of the step_index field may be extended to support input images that are themselves derived image items. In this variant extension, an input image may be replaced by a progressive reconstruction step of itself as described in a ‘prdi’ item property associated with this input image.

In this variant extension, if an input image is contained in a ‘prgr’ entity group, the step_index value is the 0-based index inside the ‘prgr’ entity group of the image item to use as a replacement for this input image. If an input image has an associated ‘prdi’ item property, the step_index value is the 0-based index inside the ‘prdi’ item property of the progressive step to use for building the replacement for this input image. If an input image is neither contained in a ‘prgr’ entity group nor has an associated ‘prdi’ item property, then the step_index value is 0.

If an input image is both contained in a ‘prgr’ entity group and has an associated ‘prdi’ item property, then the step_index value is used as an index either in the ‘prgr’ entity group or in the ‘prdi’ item property. Values from 0 to the position minus one of the input image inside the ‘prgr’ entity group are used to index items inside the ‘prgr’ entity group. Values starting at the position of the input image inside the ‘prgr’ entity group are used to index progressive rendering steps in the ‘prdi’ item property.

Possibly, a new field, derived_index, may be introduced in the definition of the progressive derived item information item property for indicating the progressive rendering step to use as a replacement for an input image that is a derived image item. Using this new field, if an input image has no associated ‘prdi’ item property, then the derived_index field is set to the value 0. If the input image has an associated ‘prdi’ item property, then the derived_index value is the 0-based index inside the associated ‘prdi’ item property of the progressive rendering step to use as a replacement for this input image. The combination of the usage of this derived_index field with the step_index field may be similar to the combination of the usage of the layer_index field with the step_index field. Other variants of possibility described for the layer_index field may also apply to the derived_index field. Preferably, the derived_index field and the layer_index field are not used together with non-zero values as they correspond to different kinds of input items.

Possibly, as described in the third variant, the step_index field may combine the usage of these three different fields: step_index, derived_index and layer_index.

Possibly, in either the first or second variant of this embodiment, or where applicable elsewhere, the meaning of the layer_index field may be extended to support the case of an input image that is a derived image having a single input image that has several layers.

In this variant extension, if an input image is a derived image item and has a single input image that has an associated ‘plai’ item property, then the layer_index is the 0-based index inside the associated ‘plai’ item property of the set of layers to use for reconstructing the replacement of the input image.

Possibly, this usage of the layer_index field may be extended to references from an input image to an image item using a chain of references through derived items. For example, the layer_index field may be used as the 0-based index inside a ‘plai’ item property associated with an image item that is the single input image of a derived image item that is itself the single input image of the derived image item that is the input image indicated in the progressive derived item information item property by the input_item_index field.

Possibly, in a similar manner, the meaning of the step_index field or of the derived index field may be extended to references from an input image to an image item using either a single derived items or a chain of references through derived items. For example. The derived_index field may be used as the 0-based index inside a ‘prdi’ item property associated with a grid item that is the single input image of a derived image item that is the input image indicated in the progressive derived item information item property by the input_item_index field,

Possibly, the meaning of the layer_index field may be extended to support the case of an input image that is a derived image having several input images with one or more layers.

In this variant extension, if an input image is a derived image item and has several input images and at least one of these input images has an associated ‘plai’ item property, then the layer_index is used for all the input images with an associated ‘plai’ item property as the 0-based index inside their respective associated ‘plai’ item property of the respective set of layers to use for reconstructing the respective replacements of the input images. If the layer_index is greater than or equal to the number of layer sets described in an associated ‘plai’ item property for an input image, then the last layer set described by the associated ‘plai’ item property is used. If an input image has no associated ‘plai’ item property, then the input image itself is used when reconstructing the derived image item.

Possibly, in this variant extension, the layer_index value may be used differently for selecting the set of layers to use for the reconstruction of the replacement of each input image. For example, if some input images have 2 sets of layers and other input images have 3 sets of layers, the value 0 for the layer_index may be used to indicate the first set of layers for all the input images. The value 1 may be used to indicate the first set of layers for the input images with 2 sets of layers and the second set of layers for the input images with 3 sets of layers. The value 2 may be used to indicate the last set of layers for all the input images.

Possibly, in this variant extension, the meaning of the layer_index field may be extended to references from an input image to several image items using a chain of references through derived items. Possibly, the number of derived items linking the input image to the different image items may vary depending on the image items.

Possibly, in a similar manner, the meaning of the step_index field or of the derived_index field may be extended to support the case of an input image that is a derived image having several input images. Possibly, the meaning of the step_index field or of the derived_index field may be extended to references from an input image to several image items using a chain of references through derived items. Possibly, the number of derived items linking the input image to the different image items may vary depending on the image items.

Possibly, two or more of the layer_index, step_index and derived_index fields may be used jointly to support the case of an input image that is a derived image having several input images with either several layers, contained in ‘prgr’ entity groups and/or being derived image items with an associated ‘prdi’ item property. Depending on the progressive rendering information available for each of the several input images, the corresponding field is used for determining the reconstruction of the progressive step for the input image. For example, an input image may be an overlay with two input images. The first input image of the overlay may be an image item with two sets of layers indicated with an associated ‘plai’ item property. The rendering step to use for this first input image would be based on the value of the layer_index field. The second input image of the overlay may be an image item contained with a thumbnail inside a ‘prgr’ entity group. The rendering step to use for this second input image would be based on the value of the step_index field.

In a third variant of this embodiment, indication of the version to use for an input item is indicated using a single field with the following structure:

```
aligned(8) class ProgressiveDerivedInformationProperty
extends ItemFullProperty(‘prdi’, version = 0, flags = 0) {
  unsigned int(8) step_count;
  for (i=0; i < step_count; i++) {
    unsigned int(8) item_count;
    for (j=0; j < item_count; j++) {
      unsigned int(16) item_index;
      unsigned int(8)  step_index;
    }
  }
}
```

In this variant, the step_index value is the index of the progressive step corresponding to the version of the input image item to use for building the progressive step of the derived item. The progressive steps may be signalled either by an entity group of type ‘prgr’, or by a ‘plai’ item property, or by both. The item_index is similar to input_item_index described in previous variants.

The complete list of progressive steps associated to a target item to be displayed may be constructed in several stages. First, if the target item is contained in an entity group of type ‘prgr’, each item included in this entity group is added to the list as a progressive step. Preferably, items listed after the target item in the entity group are not included in the list. If the target item is not contained in such an entity group, then the target item is added to the list.

Second, if the target item has an associated ‘plai’ item property, then the target item is replaced in the list by a list of progressive steps corresponding to the layers indicated in the item property.

For example, for an image item, there is an entity group of type ‘prgr’ containing a thumbnail and the image item, and there is a ‘plai’ item property associated to the image item signalling two layers. Then the progressive steps for this image item are: the thumbnail, the first layer of the image item and the second layer of the image item.

Third, if the target item is a derived item and has an associated ‘prdi’ item property, then the target item is replaced in the list by a list of progressive steps corresponding to the progressive steps indicated in the ‘prdi’ item property.

For example, for a grid item, there is an entity group of type ‘prgr’ containing a thumbnail and the grid item, and there is a ‘prdi’ item property associated to the grid item signalling two steps. Then the progressive steps for this grid item are: the thumbnail, the first step for the grid item and the second step for the grid item.

Possibly, if an item added to the list and different from the target item has an associated ‘plai’ item property, then this item may be replaced in the list by a list of progressive steps corresponding to the layers indicated in the item property.

For example, for an image item, there is an entity group of type ‘prgr’ containing a preview and the image item, and there is a ‘plai’ item property associated to the preview signalling two layers. Then the progressive steps for this image item are: the first layer of the preview, the second layer of the preview, and the image item.

Possibly, if an item added to the list and different from the target item is a derived item and has an associated item property of type ‘prdi’, then this item may be replaced in the list by a list of progressive steps corresponding to the progressive steps indicated in the ‘prdi’ item property.

Possibly, if the target item is a derived image item without an associated ‘prdi’ item property, and at least one of the input image items of the derived image item has an associated ‘prdi’ item property, has an associated ‘plai’ item property, and/or is contained in an entity group of type ‘prgr’, then the target item is replaced in the list by a list of progressive steps corresponding to generation of the derived image item using the progressive steps for the input image item indicated in the ‘prdi’ item property or corresponding to the layers indicated in the ‘plai’ item property, and/or signalled by the entity group of type ‘prgr’. The list progressive steps for the input image item may be built as described here.

Possibly, this mechanism of obtaining progressive steps for a derived image item is used only if the derived image item has a single input image item.

Preferably, a derived image item with several input image items has an associated ‘prdi’ item property in order not to rely on this mechanism.

For example, for a derived item that is a rotation of an image item with two layers, the progressive steps are: the rotation of the first layer of the image item, and the rotation of the second layer of the image item.

As another example, for a derived item that is a rotation of an image item with two layers, the image item being contained in an entity group of type ‘prgr’ with a thumbnail, the progressive steps for the derived item are: the rotation of the thumbnail, the rotation of the first layer of the image item, and the rotation of the second layer of the image item.

Possibly, several successive references from a derived item to an input image item may be followed.

For example, for a derived item that is a crop of another derived item that is itself a rotation of an image item with two layers, the progressive steps are: the crop of the rotation of the first layer of the image item, and the crop of the rotation of the second layer of the image item.

Possibly, if an item added to the list and different from the target item is a derived item without an associated ‘prdi’ item property, the same process may be used to replace the item by a list of progressive steps.

In a fourth variant, a single item property combines the information contained in the ‘prgr’ entity group, in the ‘prdi’ item property and in the ‘plai’ item property. This progressive information item property may be described by the following structure:

```
aligned(8) class ProgressiveInformationProperty
extends ItemFullProperty(‘prif’, version = 0, flags = 0) {
  // Number of progressive steps.
  unsigned int(8) step_count;
  for (i=0; i < step_count; i++) {
    unsigned int(32) step_item_id;
    unsigned int(8) layer_index;
    unsigned int(8) item_count;
    for (j=0; j < item_count; j++) {
      unsigned int(16) item_index;
      unsigned int(8)  step_index;
    }
  }
}
```

In this structure, the step_count indicates the number of progressive steps described inside the progressive information item property. It corresponds to the number of reconstruction steps for the image item associated to this property.

For each progressive step, the step_item_id indicates the identifier, i.e., the item_ID, of the image item corresponding to the step.

For each progressive step, the layer_index indicates the index of the layer corresponding to the progressive step for the image item identified by the step_item_id field. If the image item has no layers, then the value of layer_index is 0.

For each progressive step, if the identified image item is a derived item, the item_count value indicates the number of sub-image versions contained in the progressive step's refinements of this derived item. If the identified image item is not a derived item, then the value of item_count is 0.

The item_index and step_index fields are similar to those described in ‘prdi’ item property in previous variants. However, in this variant, the complete list of progressive steps may be reconstructed directly from the ‘prif’ item property associated to the image item identified by the item_index field. Therefore, the step_index value may be an index into the list of progressive steps defined by ‘prif’ item property associated to the identified image item.

In a fifth variant, combining this fourth embodiment and the second embodiment, for each refinement step, the position of the last byte corresponding to this refinement step is specified.

These positions may be indicated for each progressive step using an item property associated with the image item. This progressive step end property may be described by the following structure:

```
aligned(8) class ProgressiveInformationProperty
extends ItemFullProperty(‘prif’, version = 0, flags) {
  unsigned int(1) layer_based;
  unsigned int(7) reserved;
  unsigned int(8) num_steps;
  for (i=0; i < num_steps; i++) {
    unsigned int(32) last_byte_position;
  }
}
```

In this structure, the layer_based value is a flag indicating whether the progressive reconstruction steps for the associated item are based on layers or on versions of input image items for a derived image item. If the value of the layer_based field is 1, then the progressive reconstruction steps for the associated item are based on encoding layers of this image item. Otherwise, the associated item is a derived image item, and its progressive reconstruction steps are based on using different versions of its input image items.

The num_steps value indicates the number of reconstruction steps for the associated image item.

The last_byte_position indicates last byte in the HEIF file for the reconstruction step. When the layer_based field is 1, this last_byte_position indicates the last byte of a layer of the associated image item. When the layer_based field is 0, this last_byte_position indicates the last byte of a version of an input image for the associated image item, which is a derived image item.

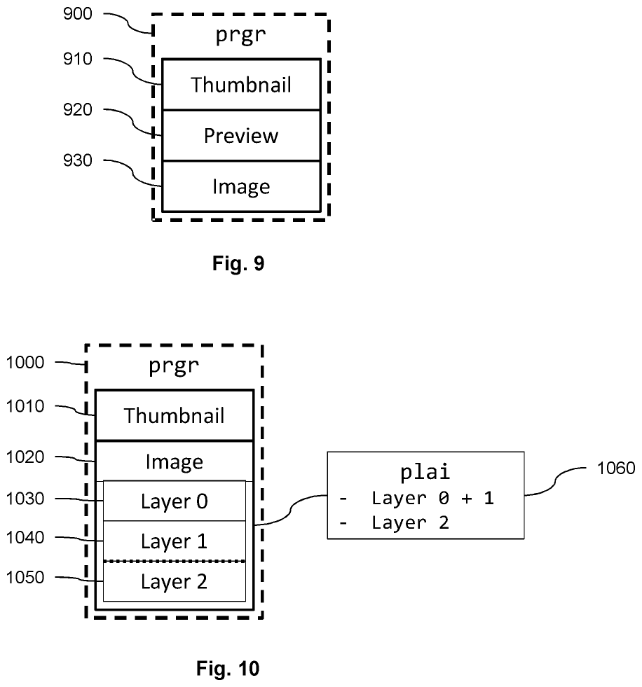

FIG. 9 illustrates an example of describing the progressive rendering for an image item 930 using a ‘prgr’ entity group 900. The entity group contains the image item and a thumbnail 910 and a preview 920. The thumbnail and/or the preview may be used for a progressive rendering of the image item.

FIG. 10 illustrates an example of describing the progressive rendering for image item 1020 encoded with several layers 1030, 1040 and 1050. The image item 1020 is contained in a ‘prgr’ entity group 1000 alongside a thumbnail 1010, indicating that the thumbnail is an alternative version of the image item that may be used for a progressive rendering of the image item.

In addition, a ‘plai’ item property 1060 is associated with the image item 1020, indicating that two progressive steps for the image item may be used for a progressive rendering. The first progressive step uses the layer 0, 1030, and the layer 1, 1040, of the image item. The second progressive step uses in addition the layer 2, 1050, of the image item.

In this example, the main image corresponds to the reconstructed image from layer 2 (1050) of image item 1020 (possibly depending on previous layers when some coding dependencies between the layers exist), and the layers 1030, 1040 and 1050 correspond to sub-images of the image item 1020. In this example, each layer or sub-image version is the sub-image itself.

FIG. 11 illustrates an example of describing the progressive rendering for a derived image item 1120 which is a grid. The derived image item is contained in a ‘prgr’ entity group 1100 alongside a thumbnail 1110, indicating that the thumbnail is an alternative version of the image item 1120 that may be used for a progressive rendering of the image item 1120.

In this example, the main image corresponds to the derived image item 1120.

This grid image item 1120 is composed of four input image items arranged in a 2×2 grid. These input image items are C0, 1132, C1, 1142, C2, 1152, C3, 1162. Each input image item also has a lower-quality version, name respectively L0 to L3. These lower-quality versions are associated with their respective input image item by being contained in a ‘prgr’ entity group. In this way, the input image item C0, 1132, and its lower-quality version L0, 1131, are contained in a ‘prgr’ entity group 1130. In the same way the input image item C3, 1162, and its lower-quality version L3, 1161, are contained in a ‘prgr’ entity group 1160.

In addition, a ‘prdi’ item property 1125 is associated with the image item 1120, indicating that three progressive steps for the image item may be used for a progressive rendering. The first progressive step uses the lower-quality versions L0, L1, L2 and L3 as replacement for the input image items C0, C1, C2 and C3. The second progressive step replaces L0 and L2 with the corresponding image items C0 and C2, resulting in a full-quality left column of the grid and a lower-quality right column. The third progressive step replaces L1 and L3 with the corresponding image items C1 and C3, resulting in a full-quality for the whole grid.

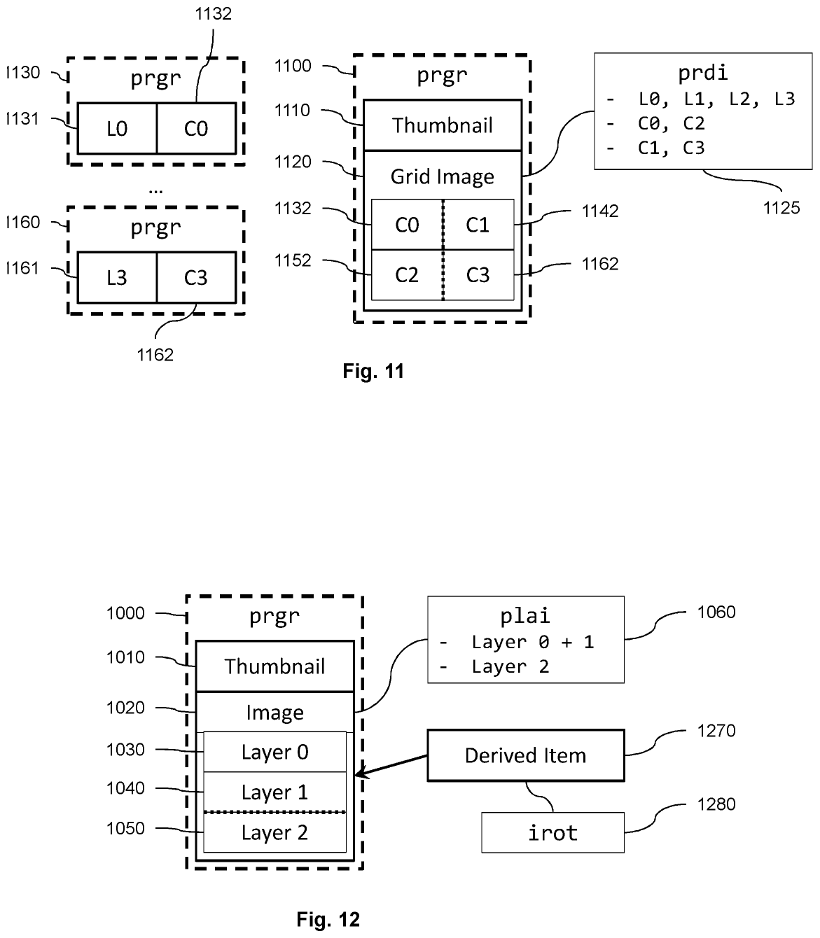

FIG. 12 expands upon the example illustrated by FIG. 10 by adding a derived image item 1270 using the layered image 1020 as its input image item. In this example, the main image corresponds to the derived image item 1270. This derived image item 1270 applies a rotation on its input image item as indicated by the associated ‘irot’ item property 1280.

In this example, a progressive rendering of the derived image item 1270 may be realized by first rendering the thumbnail included in the same ‘prgr’ entity group as the input image item, and by applying the rotation indicated by the ‘irot’ item property to it. Then, a second rendering step may be realized by rendering the layer 0 and layer 1 of the input image item, as indicated by the ‘plai’ item property 1060, and by applying the rotation indicated by the ‘irot’ item property to these layers. The last rendering step may be the rendering of the full input image item with the application of the rotation to it.

The derived image item 1270 may be included alone in a ‘prgr’ entity group to indicate that it supports progressive rendering. This indication may also be realized by a specific item property associated to it, such as the ‘prog’ item property described hereafter.

Possibly, in a variant of this example, the thumbnail 1010 may not be associated with the layered image item 1020 through the ‘prgr’ entity group 1000, but the thumbnail 1010 may be associated directly with the derived image item 1270 through a ‘prgr’ entity group. In this variant, the thumbnail 1010 would also have an associated ‘irot’ property or would already contain a rotated image. In this variant, the progressive rendering of the derived image item 1270 may be realized by first rendering the thumbnail, without applying the rotation indicated by the ‘irot’ item property 1280 associated with the derived image item. Then, a second and a third rendering steps may be realized by using the layers of the input image item as described previously.

Possibly, in another variant of this example, both the layered image item 1020 and the derived item 1270 are contained in a ‘prgr’ entity groups associating each of them to a different thumbnail. Preferably, in this variant, for the progressive rendering of the derived item 1270, the thumbnail associated with it through a ‘prgr’ entity group is used and the thumbnail 1010 associated with the layered image item 1020 through the ‘prgr’ entity group 1000 is ignored. Possibly, if the thumbnail 1010 may be used in place of the thumbnail associated with the derived item 1270, for example it this thumbnail 1010 is available before the thumbnail associated with the derived item 1270. Possibly, both thumbnails may be used for different progressive rendering steps of the derived item 1270, for example if these thumbnails have different quality levels.

All the variations described for the previous variants may also be used in this variant where applicable.

Embodiment Combination

Possibly, two or more embodiments of the invention can be combined. In a combination of embodiments, the structures describing the progressive information related to the different embodiments may be combined. These structures may be kept separate.

In particular, it may be advantageous to combine the refinement pattern embodiment with one of the other embodiments. In this combination the progressive refinement pattern indicates the progressive refinement strategy used in the HEIF file, while the offset indication or the item indication specifies the refinements of each progressive step.

For example, an item property for specifying both a progressive refinement pattern and a location for each progressive step may have the following structure:

| aligned(8) class ProgressivePatternLocationProperty | |
|---|---|
| extends ItemFullProperty(‘pplo’, version = 0, flags = 0) { | |
| unsigned int(8) | pattern_type; |
| unsigned int(1) | reverse_flag; |
| unsigned int(1) | bidirectional_flag; |
| unsigned int(1) | parameter_flag; |
| unsigned int (5) | reserved; |
| unsigned int(8) | scale; |
| if (parameter_flag = = 1) { | |
| unsigned int(16) | parameter; |
| } | |
| unsigned int(16) step_count; | |
| for (i=0; i < step_count; i++) { | |
| if (flags & 1) { | |
| unsigned int(32) | item_index; |
| } | |
| else { | |
| unsigned int(16) | item_index; |
| } | |
| unsigned int(16) | extent_index; |

}
}

Possibly some part of an embodiment of the invention can be combined with another embodiment of the invention.

Implementation Variants

In the variants that indicate sub-images through their identifiers, instead of specifying the identifier of each sub-image, the index of the sub-image in the Item Reference Entry linking the main image to the sub-images may be used.

Possibly instead of specifying several progressive steps in a single item property, each progressive step may be specified in its own item property. These item properties may be ordered according to the progressive step order.

Possibly a different item property for describing the progressive information is used for each type of main image. For example, there may be a specific item property for describing the progressive information linked to a grid item and a different item property for describing the progressive information linked to an overlay item, each with its own list of pattern_type values.

Possibly the progressive information may be contained in a new item, a progressive item, for example with the ‘prog’ type. This progressive item may have the same structure as one of the item properties described in this invention. This progressive item may be associated with the main image item it applies to with an item reference, for example with the ‘prog’ 4cc. This item reference may be from the progressive item to the image item or from the image item to the progressive item.

Possibly a progressive item may specify a single progressive step. In this case, an item reference may link the main image item to the progressive items describing progressive steps for this main image. The progressive items may be ordered in the item reference entry according to the order of their respective progressive steps.

Possibly the progressive information may be contained in a new box, a progressive box, for example with the ‘prog’ 4cc. This new box may be located inside the ‘meta’ box of the HEIF file. This progressive box may have the same structure as one of the item properties described in this invention. In addition, this progressive box may contain an indication of the main image it applies to, for example by specifying the identifier of the main image item. There may be as many instances of this progressive box as there are image items supporting a progressive rendering in the HEIF file.

Possibly a progressive box may specify a single progressive step. In this case the progressive box may include the progressive step number.

Possibly, a progressive step description may include a progressive step number.

Possibly different sizes may be used for some of the various fields described here.

Possibly variable sizes may be used for some of the various fields described here. Possibly the size of a field may be based on the ‘flags’ parameter of the box containing the field, on the ‘version’ of this box, or on a flag field included in this box. Possibly the size of several fields may depend on the same indication.

Possibly, the progressive information may indicate the progressive step's content instead of the progressive step's refinements.

Possibly the progressive steps for a main image are not organized as a list but as a directed acyclic graph. This means that a progressive step may have two or more following progressive steps and that a progressive step may have two or more preceding progressive steps. This also means that a progressive step should not be followed or preceded by itself, directly or indirectly. Such an organization is advantageous when the HEIF file is not intended to be loaded sequentially or when the content of the main image span several files that may be loaded in an undetermined order.

Progressive Step Variants

Preferably, the specification order for the progressive steps corresponds to the order of these progressive steps.

Possibly, some progressive steps may be empty or missing.

Possibly, the progressive information may define progressive steps for a progressive loading of the low-quality versions of the sub-images. In the example of FIG. 4f, using a center to border progressive refinement pattern, the first progressive step may include only the low-quality version of the center sub-image: ‘l5’, then the second progressive step refinements may include the low-quality version of the four sub-images ‘l2’, ‘l4’, ‘l6’, and ‘l8’.

Possibly, after the last progressive step, some high-quality version of some sub-images may be missing.

Possibly, one or more versions of a sub-image may be missing.

File with Multiple Content

Possibly, an HEIF file may include several image items with associated progressive information. The data for these image items may be interleaved or ordered sequentially.

For example, an HEIF file may contain a first image item with a progressive refinement pattern as described by FIG. 4f and a second image item with a progressive refinement pattern as described by FIG. 4g. The different sub-image versions for these image items may be organized as follows. First, all the low-quality versions of the sub-image of the first image item are stored, followed by the low-quality versions of the sub-image of the second image item. Then the high-quality version of the first row of the first item are stored, followed by the high-quality version of the first and second column of the second item, and so on.

For the same example, the different sub-image versions of the two image items may be organized differently: first all the sub-image versions of the first image item are stored, followed by all the sub-image versions of the second image item.

Possibly the interleaving or sequential organization of an HEIF file regarding the image items supporting a progressive rendering may be indicated. This indication may be realized by a brand in the HEIF file. There may be a brand, for example ‘spro’, for indicating a sequential organization. There may be a brand, for example ‘ipro’, for indicating an interleaved organization.

Possibly an item property may indicate for each image item supporting a progressive rendering whether it is stored sequentially or in an interleaved way.

Possibly other image items not supporting a progressive rendering or other non-image items may be included in an HEIF file containing one or more image items supporting a progressive rendering. Possibly these other image items or non-image items are stored after all the progressive image items.

Possibly the progressive information associated with an image item indicates where the metadata associated with this item is stored in relation to the progressive content of this image item. For example, the progressive information may indicate that the metadata is stored after all the content of the image item. As another example, the progressive information may indicate that the metadata is stored before the high-level versions of the sub-images of the image item.

Possibly, a component of an image item may itself be composed of several sub-images. For example, an overlay item may use a grid item as one of its components. In such a case, the progressive information associated with the composed sub-image defines the different versions of this sub-image.

Properties for Entity Groups

Possibly, an item property describing progressive steps may be associated with an entity group indicating that the entities (e.g. items) declared in this group may be used for progressive rendering (for example ‘prgr’ or ‘altr’ entity group). For example, in FIG. 10, the ‘plai’ item property 1060 may be associated with the ‘prgr’ entity group 1000 (instead of image 102, as illustrated). As another example, in FIG. 11, the ‘prdi’ item property 1125 may be associated with the ‘prgr’ entity group 1100 (instead of the grid image 1120, as illustrated).

Possibly, an item property describing progressive steps associated with an entity group signals the progressive steps for the highest-quality item contained in the entity group. In the case of a ‘prgr’ entity group, this is the last item of this entity group. For example, in FIG. 11, if the ‘prdi’ item property 1125 is associated with the ‘prgr’ entity group 1100, it may describe progressive steps for the last item contained in this ‘prgr’ entity group, i.e., the grid image 1120.

Possibly, an item property describing progressive steps associated with an entity group signals progressive steps for any item contained in the entity group to which it is applicable. For example, if the item property is a ‘ppat’ item property as described in the first embodiment, it may apply to any derived item contained in the associated entity group.

Possibly, an item property describing progressive steps associated with an entity group may indicate to which item of the entity group it applies. This indication may be the item_ID of the item to which it applies, or the index of the item inside the list of entities referenced by the entity group (i.e. the index of the entity_id that is equal to the item_ID of the item in the list of entity_ids in the entity group), or any other indication.

Possibly, an item property describing progressive steps associated with an entity group may describe progressive steps for several items contained in this entity group. This property may have a structure similar to the ‘prif’ item property of the fourth variant of the fourth embodiment:

```
aligned(8) class ProgressiveGroupInformationProperty
extends ItemFullProperty(‘prgi’, version = 0, flags = 0) {
  // Number of progressive steps.
  unsigned int(8) step_count;
  for (i=0; i < step_count; i++) {
    unsigned int(8) step_item_index;
    unsigned int(8) layer_index;
    unsigned int(8) item_count;
    for (j=0; j < item_count; j++) {
      unsigned int(16) item_index;
      unsigned int(8)  step_index;
    }
  }
}
```

In this structure, the step_count indicates the number of progressive steps described inside the progressive information item property. It corresponds to the number of reconstruction steps for the entity group (e.g. a ‘prgr’, ‘altr’ entity group or any other type of entity group) associated to this property. The step_item_index indicates for each progressive step the index of the image item inside the entity group corresponding to the step. This index may be 0-based.

For each progressive step, the layer_index indicates the index of the layer corresponding to the progressive step for the image item identified by the step_item_index field. If the image item has no layers, then the value of layer_index is 0.

For each progressive step, if the identified image item is a derived item, the item_count value indicates the number of sub-image versions contained in the progressive step's refinements of this derived item. If the identified image item is not a derived item, then the value of item_count is 0. If the identified image item is a derived item, it has an associated ‘prif’ item property.

The item_index and step_index fields are similar to those described for ‘prdi’ item property in previous variants. The complete list of progressive steps may be reconstructed directly from the ‘prif’ item property associated to the input image item identified by the item_index field. Therefore, the step_index value may be an index into the list of progressive steps defined by ‘prif’ item property associated to the identified image item.

In this structure, the complete list of progressive steps for an input image used by a derived item contained in the associated ‘prgr’ entity group and identified by an item_index field may be directly reconstructed from a ‘prgi’ item property associated with the ‘prgr’ entity group containing the input image.

In this structure, some items contained in the entity group may not be described if they correspond to a single progressive step. For example, a thumbnail may have no associated progressive step described in this item property even if it may be used during the progressive rendering.

Possibly, this item property may list the progressive steps for each item contained in the entity group with the following structure:

```
aligned(8) class ProgressiveGroupItemInformationProperty
extends ItemFullProperty(‘pgii’, version = 0, flags = 0) {
  // Loop over the entities of the group.
  for (i=0; i < entity_count; i++) {
    // Number of progressive steps.
    unsigned int(8) step_count;
    for (j=0; j < step_count; j++) {
      unsigned int(8) layer_index;
      unsigned int(16) item_count;
      for (k=0; k < item_count; k++) {
        unsigned int(16) item_index;
        unsigned int(8)  step_index;
      }
    }
  }
}
```

In this structure, layer_index, item_count, item_index and step_index fields are similar to those of the ‘prgi’ item property. The entity_count value corresponds to the number of entities contained in the associated ‘prgr’ entity group. Possibly, this value may be explicitly specified in a field of the ‘pgii’ item property.

In this structure, the progressive steps are described for each item contained in the associated ‘prgr’ entity group in turn.

In this structure, the step_count field indicates the number of progressive steps described inside the progressive group item information property for the item contained in the associated ‘prgr’ entity group being described (i.e. the item corresponding to the i^{th} entity in the entity group).

In this structure, the complete list of progressive steps for an input image used by a derived item contained in the associated ‘prgr’ entity group and identified by an item_index field may be directly reconstructed from a ‘pgii’ item property associated with the ‘prgr’ entity group containing the input image.

If the item being described has a single progressive step corresponding to the rendering of the item itself, then the step count value may be set to 0.

Possibly, item properties associated with entity groups and item properties associated with image items may be used jointly in the same HEIF file. For example, in FIG. 11, the ‘prdi’ item property 1125 may be associated with the ‘prgr’ entity group 1100 and another ‘prdi’ item property (not illustrated) may be associated with the C0 image item 1132. Possibly, the item property used for describing progressive steps in association with an entity group may be the same as the item property used for describing progressive steps in association with an image item. For example, they may both be ‘prdi’ item properties. Possibly, these item properties may be of different types or have different content. For example, the item property used for describing progressive steps in association with an entity group may be a ‘prgi’ item property, while the item property used for describing progressive steps in association with an image item may be a ‘prdi’ item property.

All these possibilities of associating an item property describing progressive steps with an entity group may also apply to entity groups different from the ‘prgr’ entity group, such as for example an ‘altr’ entity group. Other item properties describing progressive steps may also be used.

Multiple Progressive Rendering

Possibly, several progressive rendering may be described for the same image item. For example, in FIG. 9, a second ‘prgr’ entity group may include only the thumbnail 910 and the image 930. Preferably, the ordering of the image data inside the HEIF file enables all the progressive rendering described. For example, in FIG. 9, if a second ‘prgr’ entity group includes the thumbnail 910, a second preview and the image 930, then both the data corresponding to the preview 920 and the data corresponding to the second preview should be stored after the data corresponding to the thumbnail 910 and before the data corresponding to the image 930.

An image item intended to be rendered may have several progressive renderings described for it. For example, an image item may be contained in several ‘prgr’ entity groups. As another example, a derived image item may be associated with several ‘prdi’ item properties. In such a case, a renderer may select any of these progressive rendering descriptions (e.g. a ‘prgr’ group, a ‘prgr’ group with a progressive step property; an item with a ‘prdi’ . . . ) for realizing the progressive rendering of the image item.

Possibly, the selection of the progressive rendering description to use may be based on the characteristics of the renderer. For example, a renderer configured to save CPU resource may select the progressive rendering description with the fewest rendering steps.

Possibly, the selection of the progressive rendering description to use may be based on the position of this description in the HEIF file. For example, if an image item is contained in several ‘prgr’ entity groups, the renderer may select the first ‘prgr’ entity group. It may also select the last ‘prgr’ entity group. As another example, the renderer may select the ‘prgr’ entity group with the lowest group_id. It may also select the ‘prgr’ entity group with the highest group_id

Possibly, the different progressive rendering descriptions may include information for helping the selection of one of them by the renderer. For example, a progressive rendering description may include information about the intended download speed when using this progressive rendering description. This information may be stored inside the item property for progressive rendering descriptions based on an item property, such as for example the ‘prdi’ item property or any other item properties previously described. This information may be stored inside an item property associated with the entity group for progressive rendering descriptions based on an entity group, such as for example the ‘prgr’ entity group.

Possibly, the different progressive rendering descriptions may include preference-related information. For example, a progressive rendering description may include a flag indicating it is the preferred progressive rendering description. This information may be stored inside the item property for progressive rendering descriptions based on an item property, such as for example the ‘prdi’ item property or any other item properties previously described, or when the primary item has progressive rendering descriptions, in a Progressive download information box at top level of the file, possibly with the initial_delay parameter set to zero for renderer to start rendering a version of a selected image without delay. This information may be stored inside an item property associated with the entity group for progressive rendering descriptions based on an entity group, such as for example the ‘prgr’ entity group. This information may be stored directly inside the entity group for progressive rendering descriptions, such as for example using different grouping types or using different versions or flags values. For example, the ‘prgr’ entity group may be used to indicate the preferred progressive rendering while the ‘prg2’ entity group may be used to indicate an alternate progressive rendering. As another example, several alternative ‘prgr’ entity groups may be declared in an ‘altr’ entity group.

Possibly, an image item may correspond to the main image of a progressive rendering description and to a rendering step of another progressive rendering description. In this case, for progressively rendering the image item, the renderer may select the progressive rendering description where the image item is the main image of the description. For example, if a first ‘prgr’ entity group contains a thumbnail and a LDR (Low dynamic Range, in opposition to High Dynamic Range) image and a second ‘prgr’ entity group contains another thumbnail, the LDR image and a HDR image, when progressively rendering the LDR image, the renderer may select the first ‘prgr’ entity group.

Possibly, a renderer may combine the progressive rendering steps corresponding to different progressive rendering descriptions. For example, if a first ‘prgr’ entity group contains a first thumbnail, a first preview and an image item and a second ‘prgr’ entity group contains a second thumbnail, a second preview and the image item, the renderer may render progressively the image item by first displaying the first thumbnail, then display the second preview and finally displaying the image item.

Possibly, before selecting a progressive rendering description, a renderer may check whether these descriptions are compatible with the ordering of image data inside the HEIF file. The renderer may select a progressive rendering description only if it is compatible with the ordering of image data inside the HEIF file.

Possibly, two or more progressive rendering description corresponding to different image items may contain common initial steps. For example, an HEIF file containing a pair of stereo image items may include each image item in its own ‘prgr’ entity group and use the same thumbnail as the first rendering step for both image items as these image items have only slight differences that may not be visible on a thumbnail.

Possibly, not all initial steps are common to all the different image items. For example, the thumbnails corresponding to the first rendering steps of the two stereo image items may be different while the previews corresponding to the second rendering steps may be the same.

Possibly, the progressive rendering of these image items may take advantage of the common initial steps.

Possibly, when rendering an image item present as an intermediary step in several progressive rendering descriptions, the renderer may select one of these rendering descriptions as described previously.

When using different progressive rendering descriptions, steps 510 and 520 of FIG. 5 are modified to obtain multiple progressive specifications and to generate multiple progressive information.

When using different progressive rendering descriptions, step 620 of FIG. 6 is modified to extract the multiple progressive information and to select one of them.

Note that all these possibilities described in reference to variants of the fourth embodiment may also apply to other variants or other embodiments where applicable.

Progressive Rendering for Entity Groups

Possibly, progressive rendering information may be associated with an entity group. For example, a thumbnail may be used as a temporary replacement for a slideshow, a collection or an album of image items. This thumbnail may be different from the thumbnail of the first image of the slideshow, collection or album.

Possibly, a ‘prgr’ entity group may be used to indicate that other items or entity groups may be used as a temporary replacement for rendering an entity group. For example, a ‘prgr’ entity group may contain a thumbnail and a slideshow entity group to indicate that the thumbnail may be used in the progressive rendering of the slideshow entity group. As another example, a ‘prgr’ entity group may contain a thumbnail, a first slideshow entity group and a second slideshow entity group. The first slideshow entity group may contain previews of the image items contained in the second slideshow entity group. The progressive rendering of the second slideshow entity group may be realized by rendering first the thumbnail, then the first slideshow entity group and finally the second slideshow entity group. As a third example, a ‘prgr’ entity group may contain a thumbnail and a slideshow entity group. In addition, each image item contained in the slideshow entity group is also contained in a ‘prgr’ entity group alongside its thumbnail. The progressive rendering of the slideshow entity group may be realized by rendering first its thumbnail then the slideshow itself. As part of rendering the slideshow, each image item of the slideshow may be rendered progressively by first displaying its thumbnail before displaying the image item itself, for example when the next image in the slideshow is not yet received by the player. Instead of freezing, the user may see the next image progressively appearing by applying a reconstruction step for this next image.

Possibly, specific item properties may be used to describe the progressive rendering steps associated with an entity group.

Note that all these possibilities described in reference to variants of the fourth embodiment may also apply to other variants or other embodiments where applicable.

Possibly, the progressive rendering of an image item may be used even if the whole data for the image item is already available to enable a fast rendering of the image item. For example, for reviewing quickly all the images of a slideshow, an initial progressive rendering step of the images may be rendered instead of the image themselves. This may be used by user to quickly check his slideshow or to achieve some fast forward in the slideshow.

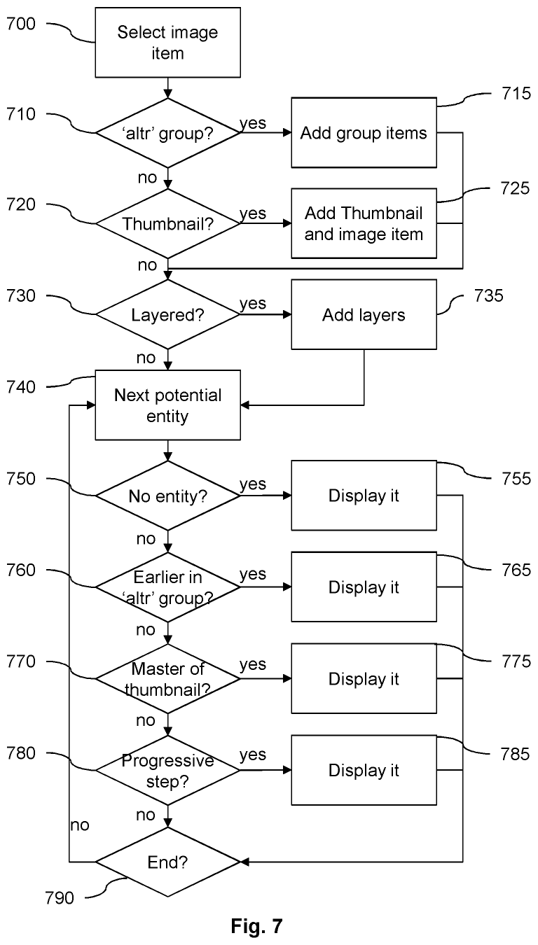

FIG. 7 illustrates the main steps for a progressive rendering of an HEIF file generated according to embodiments of the invention. It is a more generic alternative to the main steps illustrated by FIG. 6. Note that these steps are described in reference to image items, but could also be used for a progressive rendering of a track, in particular for a track for which the temporal information is not necessarily meaningful, like ‘pict’ track or a sequence of independent still images encapsulated in a track.

In a first step 700, an image item to render is selected.

Then, in steps 710 to 735, the potential entities for progressive refinement are determined. First, the image item itself is regarded as a potential entity for progressive refinement.

At step 710, it is checked whether the selected image item is included in an entity group of type ‘altr’. If this is the case, then at step 715, the image items contained in that entity group are regarded as potential entities for progressive refinement. The next step is step 730.

Otherwise, at step 720, it is checked whether the selected image item has an associated thumbnail image item. If this is the case, at step 725, the associated thumbnail is regarded as a potential entity for progressive refinement. The next step is step 730.

At step 730, it is checked whether the selected image item is encoded as a multi-layer image with several layers. If this is the case, at step 735, the different encoded layers are regarded as potential entities for progressive refinement. If a progressive layer item property is associated with the selected image item, only the layers indicated in this item property are regarded as potential entities for progressive refinement.

At step 740, the next potential entity is obtained. For example, the loading of data is monitored for checking when data corresponding to a new item or a new layer has been loaded. If the loaded data enables to obtain a new image item regarded as a potential entity, this image item is the next potential entity. If the loaded data enables to obtain a new layer regarded as a potential entity, then this layer is the next potential entity. If the loaded data enables to obtain a new image item that is a sub-image of a potential entity, then this potential entity is the next potential entity. Otherwise, the monitoring continues.

Then at step 750, it is checked whether any entity has been rendered. If no entity has been rendered, then at step 755, the next potential entity is rendered. The next step is step 790.

Otherwise, at step 760, it is checked if an ‘altr’ group was found at step 710, and if true, whether the next potential entity is earlier in this ‘altr’ group than the currently rendered entity. If true, then at step 765, the next potential entity is rendered. The next step is step 790.

Otherwise, at step 770, it is checked if the currently rendered entity is a thumbnail and the next potential entity its master image. If true, then at step 775, then next potential entity is rendered. The next step is step 790.

Otherwise, at step 780, it is checked if the next potential entity is the same as the currently rendered entity and has progressive steps associated with it. If this is true, it is further checked whether a new progressive step can be rendered. If this is true, then at step 785, this new progressive step is displayed. The next step is step 790.

At step 790, it is checked whether the end of the HEIF file has been reached. If this is the case, no more steps are executed. Otherwise, the next step is step 740.

The ‘altr’ grouping type may be used to associate with an image item other image items that may be used in a progressive rendering of this image item. Some variants of the embodiments of this invention rely on ‘altr’ entity groups for indicating all the versions of a sub-image. Other grouping types may be used for indicating which image items may be used in a progressive rendering of a given image item. A specific grouping type, for example ‘prog’, may be used for associating image items in view of progressive rendering.

Possibly, a progressive refinement pattern item property may be associated with any image item for indicating the progressive refinement strategy selected for this image item.

Possibly, a progressive refinement item property may be associated with an image item for indicating that this image item support progressive rendering. The structure of this progressive refinement item property may be the following:

aligned(8) class ProgressiveProperty
extends ItemFullProperty (‘prog’, version = 0, flags = 0) {
}

Possibly, some progressive information may be associated with an entity group for indicating that the entire group supports progressive rendering. For example, a left-right progressive rendering pattern may be associated with a panorama group for indicating that the panorama itself can be rendered in a progressive way.

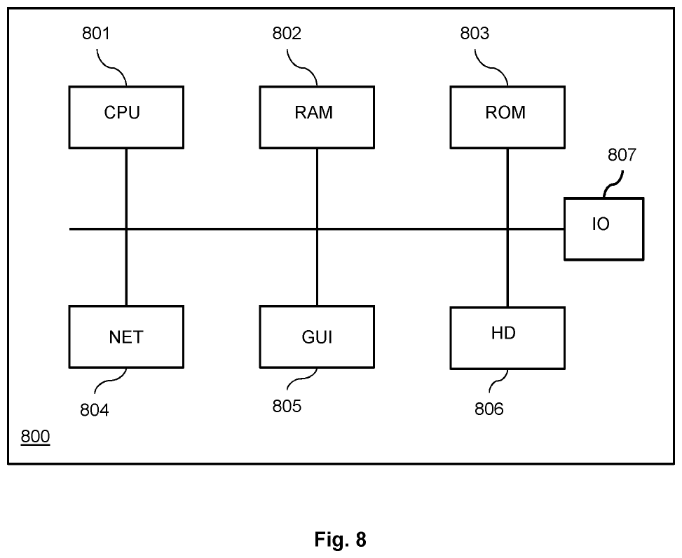

FIG. 8 is a schematic block diagram of a computing device 800 for implementation of one or more embodiments of the invention. The computing device 800 may be a device such as a micro-computer, a workstation or a light portable device. The computing device 800 comprises a communication bus connected to:
a central processing unit 801, such as a microprocessor, denoted CPU;
a random access memory 802, denoted RAM, for storing the executable code of the method of embodiments of the invention as well as the registers adapted to record variables and parameters necessary for implementing the method according to embodiments of the invention, the memory capacity thereof can be expanded by an optional RAM connected to an expansion port, for example;
a read-only memory 803, denoted ROM, for storing computer programs for implementing embodiments of the invention;
a network interface 804 is typically connected to a communication network over which digital data to be processed are transmitted or received. The network interface 804 can be a single network interface, or composed of a set of different network interfaces (for instance wired and wireless interfaces, or different kinds of wired or wireless interfaces). Data packets are written to the network interface for transmission or are read from the network interface for reception under the control of the software application running in the CPU 801;
a graphical user interface 805 may be used for receiving inputs from a user or to display information to a user;
a hard disk 806 denoted HD may be provided as a mass storage device;
an I/O module 807 may be used for receiving/sending data from/to external devices such as a video source or display.

The executable code may be stored either in read only memory 803, on the hard disk 806 or on a removable digital medium such as for example a disk. According to a variant, the executable code of the programs can be received by means of a communication network, via the network interface 804, in order to be stored in one of the storage means of the communication device 800, such as the hard disk 806, before being executed.

The central processing unit 801 is adapted to control and direct the execution of the instructions or portions of software code of the program or programs according to embodiments of the invention, which instructions are stored in one of the aforementioned storage means. After powering on, the CPU 801 is capable of executing instructions from main RAM memory 802 relating to a software application after those instructions have been loaded from the program ROM 803 or the hard-disc (HD) 806 for example. Such a software application, when executed by the CPU 801, causes the steps of the flowcharts of the invention to be performed.

Any step of the algorithms of the invention may be implemented in software by execution of a set of instructions or program by a programmable computing machine, such as a PC (“Personal Computer”), a DSP (“Digital Signal Processor”) or a microcontroller; or else implemented in hardware by a machine or a dedicated component, such as an FPGA (“Field-Programmable Gate Array”) or an ASIC (“Application-Specific Integrated Circuit”).

Although the present invention has been described herein above with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

Each of the embodiments of the invention described above can be implemented solely or as a combination of a plurality of the embodiments. Also, features from different embodiments can be combined where necessary or where the combination of elements or features from individual embodiments in a single embodiment is beneficial.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of encapsulating image data in a media file, the image data being related to a main image to be generated based on a plurality of sub-images, wherein the method comprises:
obtaining the plurality of sub-images, each sub-image being provided in at least one version corresponding to at least one progressive step of a set of consecutive progressive steps;
generating descriptive metadata for describing information about the main image and the at least one version of the plurality of sub-images;
encapsulating the at least one version of the plurality of sub-images and the descriptive metadata in the media file;
wherein the method further comprises:
generating a progressive information defining the set of consecutive progressive steps for generating at least one version of the main image, each progressive step being associated with a set of sub-images versions required to generate a corresponding version of the main image; and
embedding the progressive information in the descriptive metadata.

2. The method of claim 1, wherein each sub-image represents a different subset of the layers of the main image.

3. The method of claim 1, wherein sub-images are input images, at least one input image being associated with different version of input image.

4. The method of claim 21, wherein the progressive information comprises data for identifying, for each progressive step, a position in the file of the sub-image version data associated with the progressive step.

5. The method of claim 4, wherein the position indicates the last byte of sub-image version data in the file associated with the progressive step.

6. The method of claim 4, wherein the position comprises an offset and a length to indicate the sub-image version data associated with the progressive step.

7. The method of claim 4, wherein the position comprises a list of extents of the sub-image version data associated with the progressive step.

8. (canceled)

9. The method of claim 21, wherein sub-image versions being described as image items, the progressive information comprises data for identifying, for each progressive step a list of the image item identifiers identifying the image items associated with the progressive step.

10. The method of claim 3, wherein input image versions being described as image items, the progressive information comprises for each progressive step a number of image items comprised in the progressive step.

11. The method of claim 10, wherein at least one input image version being composed of a plurality of layers, the progressive information further comprises data for identifying a layer identifier associated with the image item identifier of the input image version.

12. The method of claim 1, wherein generating a progressive information comprises generating a progressive rendering data structure comprising data for determining, for each progressive rendering step, the number of image items to use for the reconstruction of the main image, wherein the number of image items for a progressive rendering step is described as a difference from the previous step.

13. The method of claim 12, wherein the progressive rendering data structure further comprises a number of progressive rendering steps.

14. The method of claim 1, wherein the progressive information characterizes a construction of the main image so that its quality is gradually improved.

15. The method of claim 1, wherein the progressive information is associated with the main image.

16. The method of claim 1, wherein the main image is part of an entity group, and the progressive information is associated with at least one entity of the group.

17. A method of generating a main image to be generated based on a plurality of sub-images from an image data file, wherein the method comprises:
obtaining, from the image data file, descriptive metadata describing information about the main image and at least one version of the plurality of sub-images, each sub-image being provided in at least one version corresponding to at least one progressive step of a set of consecutive progressive steps;
obtaining, from the descriptive metadata, a progressive information defining the set of consecutive progressive steps for generating at least one version of the main image, each progressive step being associated with a set of sub-image versions required to generate a corresponding version of the main image;
obtaining image data corresponding to the sub-images from the image data file; and
generating at least two versions of the main image corresponding to at least two progressive steps, each version of the main image being generated when the set of sub-image versions associated with respective progressive steps is obtained from the image data file.

18. (canceled)

19. A non-transitory computer-readable storage medium storing instructions of a computer program for implementing a method according to claim 1.

20. A non-transitory computer-readable storage medium storing instructions of a computer program for implementing a method according to claim 17.

21. A device for encapsulating image data in a media file, the image data being related to a main image to be generated based on a plurality of sub-images, wherein the device comprises a processor configured for:
obtaining the plurality of sub-images, each sub-image being provided in at least one version corresponding to at least one progressive step of a set of consecutive progressive steps;
generating descriptive metadata for describing information about the main image and the at least one version of the plurality of sub-images;
encapsulating the at least one version of the plurality of sub-images and the descriptive metadata in the media file;
wherein the method further comprises:
generating a progressive information defining the set of consecutive progressive steps for generating at least one version of the main image, each progressive steps being associated with a set of sub-images versions required to generate a corresponding version of the main image; and
embedding the progressive information in the descriptive metadata.

22. A device for generating a main image to be generated based on a plurality of sub-images from an image data file, wherein the device comprises a processor configured for:
obtaining, from the image data file, descriptive metadata describing information about the main image and at least one version of the plurality of sub-images, each sub-image being provided in at least one version corresponding to at least one progressive step of a set of consecutive progressive steps;
obtaining, from the descriptive metadata, a progressive information defining the set of consecutive progressive steps for generating at least one version of the main image, each progressive step being associated with a set of sub-image versions required to generate a corresponding version of the main image;
obtaining image data corresponding to the sub-images from the image data file; and
generating at least two versions of the main image corresponding to at least two progressive steps, each version of the main image being generated when the set of sub-image versions associated with respective progressive steps is obtained from the image data file.
